(19) United States
(12) Patent Application Publication
(10) Pub. No.: US 2023/0216117 A1
(43) Pub. Date: Jul. 6, 2023

(54) SECONDARY BATTERY

(71) Applicant: MURATA MANUFACTURING CO., LTD., Kyoto (JP)

(72) Inventors: Taichi KATSUMOTO, Kyoto (JP); Masayuki KAGEYAMA, Kyoto (JP); Yoshiichi HORIKOSHI, Kyoto (JP)

(21) Appl. No.: 18/120,057

(22) Filed: Mar. 10, 2023

Related U.S. Application Data
(63) Continuation of application No. PCT/JP2021/027132, filed on Jul. 20, 2021.

(30) Foreign Application Priority Data
Sep. 17, 2020 (JP) 2020-156157

(51) Int. Cl. H01M 50/171; H01M 50/109; H01M 50/148; H01M 50/538; H01M 10/0525

(52) U.S. Cl. CPC H01M 50/171; H01M 50/109; H01M 50/154; H01M 50/538; H01M 10/0525

(57) ABSTRACT

A secondary battery includes an outer package member, a battery device, and an insulating member. The outer package member has a flat and columnar shape and includes a first bottom part and a second bottom part opposed to each other. The battery device is contained inside the outer package member, and has a first through hole extending from the first bottom part toward the second bottom part. The insulating member is adhered in part to the battery device between the second bottom part and the battery device, and has a second through hole at a position overlapping with the first through hole.

### CROSS REFERENCE TO RELATED APPLICATIONS

The present application is a continuation of PCT patent application no. PCT/JP2021/027132, filed on Jul. 20, 2021, which claims priority to Japanese patent application no. JP2020-156157, filed on Sep. 17, 2020, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member, and the battery device includes a positive electrode, a negative electrode, and an electrolyte. A configuration of the secondary battery has been considered in various ways in order to achieve various purposes.

Specifically, in order to achieve both suppression of occurrence of an internal short circuit and ensuring of safety upon overcharge, an insulating plate is disposed between an electrode group and a bottom surface of a battery case, and the insulating plate has a heatproof temperature higher than or equal to a heatproof temperature of a separator.

In order to prevent misalignment of an insulating plate, an electrode plate group and the insulating plate attached to a bottom surface of the electrode plate group are contained inside a battery case, and the insulating plate has multiple projections or multiple grooves.

In order to improve an ability of a high-density electrode assembly to be impregnated with an electrolytic solution, the electrode assembly and a bottom insulating plate are contained inside a can, and the bottom insulating plate has multiple rectangular or circular openings.

A crimped can formed by means of crimping processing is used as a can to contain a battery device. In the crimped can, a metal cup and a metal cover are crimped to each other via a gasket.

### SUMMARY

The present technology relates to a secondary battery.

Although consideration has been given in various ways regarding a configuration of a secondary battery, improvement of manufacturing stability and safety together with a battery characteristic (a battery capacity) still remains insufficient. Accordingly, there is still room for improvement in terms thereof.

It is therefore desirable to provide a secondary battery that is able to improve manufacturing stability and safety while securing a battery capacity.

A secondary battery according to an embodiment of the present technology includes an outer package member, a battery device, and an insulating member. The outer package member has a flat and columnar shape and includes a first bottom part and a second bottom part opposed to each other. The battery device is contained inside the outer package member, and has a first through hole extending from the first bottom part toward the second bottom part. The insulating member is adhered in part to the battery device between the second bottom part and the battery device, and has a second through hole at a position overlapping with the first through hole.

According to the secondary battery of an embodiment of the present technology, the battery device having the first through hole is contained inside the outer package member having a flat and columnar shape and including the first bottom part and the second bottom part, and the insulating member having the second through hole at the position overlapping with the first through hole is adhered in part to the battery device between the second bottom part and the battery device. This makes it possible to improve manufacturing stability and safety while securing a battery capacity.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment of the present technology.

FIG. 2 is a sectional view of the configuration of the secondary battery illustrated in FIG. 1.

FIG. 3 is a plan view of a configuration of a main part of the secondary battery illustrated in FIG. 2.

FIG. 4 is a sectional view of a configuration of a battery device illustrated in FIG. 2.

FIG. 5 is a plan view of a configuration of an insulating film illustrated in FIG. 2.

FIG. 6 is a plan view for describing a process of forming the insulating film.

FIG. 7 is a perspective view for describing a process of manufacturing the secondary battery.

FIG. 8 is a plan view of a configuration of a secondary battery (an insulating film) of a first comparative example.

FIG. 9 is a plan view of a configuration of a secondary battery (an insulating film) of a second comparative example.

FIG. 10 is a plan view of a configuration of a secondary battery (an insulating film) of a third comparative example.

FIG. 11 is a plan view of a configuration of a secondary battery (an insulating film) of a fourth comparative example.

FIG. 12 is a plan view of a configuration of a secondary battery (an insulating film) of a fifth comparative example.

FIG. 13 is a plan view of a configuration of a secondary battery (an insulating film) of a sixth comparative example.

FIG. 14 is a plan view of a configuration of a secondary battery (an insulating film) of a seventh modification.

FIG. 15 is a plan view for describing an issue related to the secondary battery of the second comparative example.

FIG. 16 is a plan view of a configuration of an insulating film of an embodiment.

FIG. 17 is a plan view of a configuration of an insulating film of an embodiment.

FIG. 18 is a plan view of another configuration of the insulating film of an embodiment.

FIG. 19 is a sectional view of a configuration of a secondary battery of an embodiment.

FIG. 20 is a sectional view of a configuration of a secondary battery of an embodiment.

### DETAILED DESCRIPTION

One or more embodiments of the present technology are described below in further detail including with reference to the drawings.

A description is given of a secondary battery according to an embodiment of the present technology.

The secondary battery to be described here is a secondary battery that has a flat and columnar three-dimensional shape, and is commonly referred to by a term such as a coin type or a button type. As will be described later, the secondary battery includes two bottom parts opposed to each other, and a sidewall part lying between the two bottom parts. This secondary battery has a height smaller than an outer diameter. The “outer diameter” is a diameter (a maximum diameter) of each of the two bottom parts. The “height” is a distance (a maximum distance) from one of the bottom parts to another of the bottom parts.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains the battery capacity using insertion and extraction of lithium is a so-called lithium-ion secondary battery. In the lithium-ion secondary battery, lithium is inserted and extracted in an ionic state.

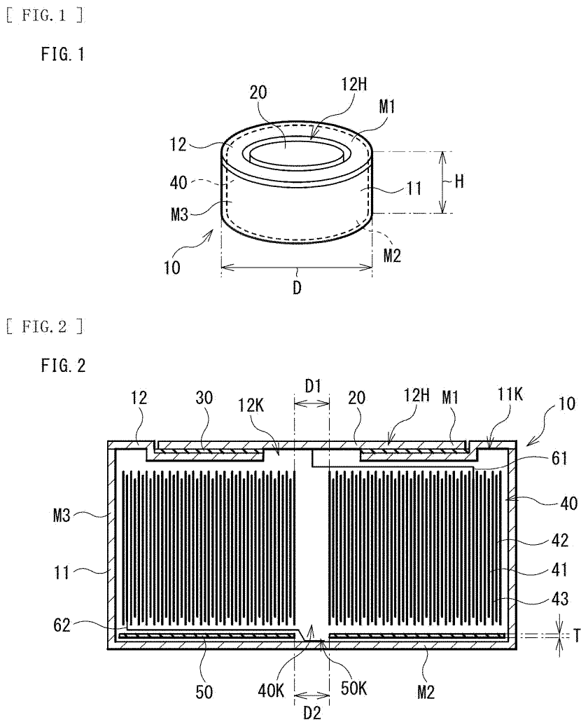

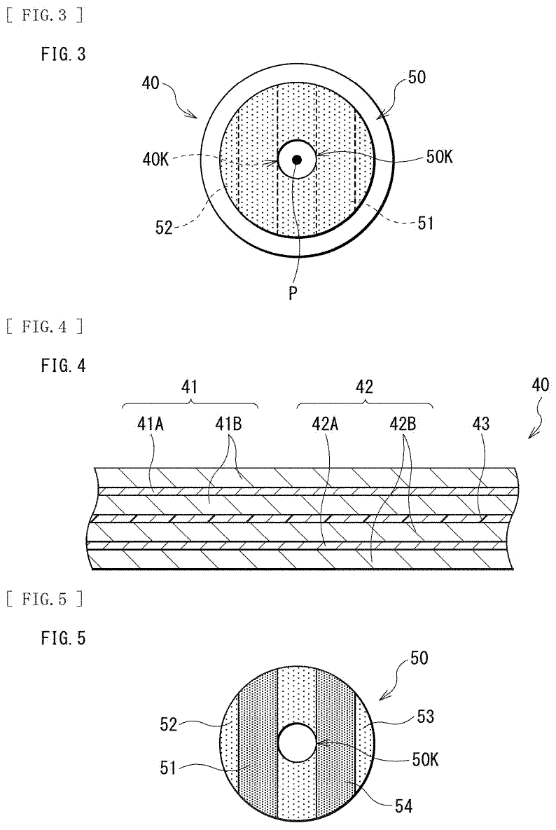

FIG. 1 illustrates a perspective configuration of the secondary battery. FIG. 2 illustrates a sectional configuration of the secondary battery illustrated in FIG. 1. FIG. 3 illustrates a planar configuration of a main part of the secondary battery illustrated in FIG. 2. FIG. 4 illustrates a sectional configuration of a battery device 40 illustrated in FIG. 2. FIG. 5 illustrates a plane of an insulating film 50 illustrated in FIG. 2.

For convenience, the following description is given with an upper side of each of FIGS. 1 and 2 assumed as an upper side of the secondary battery, and a lower side of each of FIGS. 1 and 2 assumed as a lower side of the secondary battery.

Note that in FIG. 2, for simplifying the illustration, a positive electrode 41, a negative electrode 42, a separator 43, a positive electrode lead 61, and a negative electrode lead 62 are each illustrated in a linear shape. For easy viewing of a positional relationship between the battery device 40 and the insulating film 50, FIG. 2 illustrates a state in which the insulating film 50 is separated from the battery device 40. FIG. 3 illustrates a state of each of the battery device 40 and the insulating film 50 as viewed from below. FIG. 4 illustrates only a portion of the sectional configuration of the battery device 40. FIG. 5 illustrates a state of the insulating film 50 as viewed from above.

The secondary battery to be described here has such a three-dimensional shape that a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar).

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. Although not particularly limited, an upper limit of the ratio D/H is preferably less than or equal to 25.

As illustrated in FIGS. 1 to 5, the secondary battery includes an outer package can 10, the battery device 40, and the insulating film 50. Here, the secondary battery further includes an external terminal 20, a gasket 30, the positive electrode lead 61, and the negative electrode lead 62.

As illustrated in FIGS. 1 and 2, the outer package can 10 is an outer package member having a flat and columnar shape, and has a hollow structure to contain the battery device 40 and other components therein.

Here, the outer package can 10 has a flat and cylindrical three-dimensional shape corresponding to the three-dimensional shape of the secondary battery which is flat and cylindrical. Accordingly, the outer package can 10 includes an upper bottom part M1 and a lower bottom part M2 opposed to each other, and more specifically, includes a sidewall part M3 coupled to each of the upper bottom part M1 and the lower bottom part M2, together with the upper bottom part M1 and the lower bottom part M2.

The upper bottom part M1 is a first bottom part out of the first bottom part and a second bottom part opposed to each other, and the lower bottom part M2 is the second bottom part. The sidewall part M3 is disposed between the upper bottom part M1 and the lower bottom part M2. The sidewall part M3 thus has an upper end part coupled to the upper bottom part M1, and a lower end part coupled to the lower bottom part M2. As described above, the outer package can 10 is cylindrical. Thus, the upper bottom part M1 and the lower bottom part M2 are each circular in planar shape, and a surface of the sidewall part M3 is a convexly curved surface.

The outer package can 10 includes a container part 11 and a cover part 12 that are joined to each other. The container part 11 is sealed by the cover part 12. Here, the cover part 12 is welded to the container part 11.

The container part 11 is a container member having a flat and cylindrical shape and containing the battery device 40 and other components inside. The container part 11 corresponds to the lower bottom part M2 and the sidewall part M3. Here, the container part 11 has a structure in which the lower bottom part M2 and the sidewall part M3 are integrated with each other. The container part 11 has a hollow structure with an upper end part open and a lower end part closed, and thus has an opening 11K at the upper end part.

The cover part 12 is a substantially disk-shaped cover member that closes the opening 11K of the container part 11. The cover part 12 corresponds to the upper bottom part M1. Here, the cover part 12 has a through hole 12K to allow the external terminal 20 and the battery device 40 to be coupled to each other, and is welded to the container part 11 at the opening 11K as described above. The external terminal 20 is attached to the cover part 12, and the cover part 12 thus supports the external terminal 20.

Here, the cover part 12 is so bent as to protrude in part toward the inside of the container part 11. The cover part 12 is thus recessed in part. In this case, a portion of the cover part 12 is so bent as to form a level difference toward a center of the cover part 12. Accordingly, the cover part 12 is so bent as to protrude in part toward the inside of the container part 11, thus having a recessed part 12H. The through hole 12K is provided in the recessed part 12H.

As described above, the outer package can 10 is a so-called welded can in which two members (the container part 11 and the cover part 12) are welded to each other. As a result, the outer package can 10 after undergoing welding is physically a single member as a whole, and is thus in a state of being not separable into the two members (the container part 11 and the cover part 12) afterward.

The outer package can 10 as a welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, a state of the outer package can 10 in the completed secondary battery is not a state in which two or more members lie over each other and are assembled to each other in such a manner as to be separable afterward.

In particular, the outer package can 10 as a welded can is a so-called crimpless can, being different from a crimped can which is formed by means of crimping processing. A reason for employing the crimpless can is that this increases a device space volume inside the outer package can 10, and accordingly increases an energy density per unit volume of the secondary battery. The “device space volume” refers to a volume (an effective volume) of an internal space of the outer package can 10 available for containing therein the battery device 40 which is to be involved in charging and discharging reactions.

Here, the outer package can 10 including the container part 11 and the cover part 12 is electrically conductive. The outer package can 10 is coupled to the battery device 40 (the negative electrode 42) via the negative electrode lead 62.

The outer package can 10 thus serves as an external coupling terminal for the negative electrode 42. A reason for employing such a configuration is that this makes it unnecessary for the secondary battery to be provided with an external coupling terminal for the negative electrode 42 separate from the outer package can 10, and thus suppresses a decrease in device space volume resulting from providing the external coupling terminal for the negative electrode 42. As a result, the device space volume increases, and accordingly, the energy density per unit volume increases.

Specifically, the outer package can 10 includes one or more of electrically conductive materials including, without limitation, a metal material and an alloy material. Examples of the electrically conductive materials include iron, copper, nickel, stainless steel, an iron alloy, a copper alloy, and a nickel alloy. Although the stainless steel is not particularly limited in kind, specific examples of the stainless steel include SUS304 and SUS316. Note that the container part 11 and the cover part 12 may include the same material, or may include respective different materials.

As will be described later, the outer package can 10 (the cover part 12) is insulated, via the gasket 30, from the external terminal 20 which serves as an external coupling terminal for the positive electrode 41. A reason for this is that contact (a short circuit) between the outer package can 10 (the external coupling terminal for the negative electrode 42) and the external terminal 20 (the external coupling terminal for the positive electrode 41) is prevented.

As illustrated in FIGS. 1 and 2, the external terminal 20 is an electrode terminal to be coupled to electronic equipment when the secondary battery is mounted on the electronic equipment. Here, the external terminal 20 is attached to the outer package can 10 (the cover part 12) as described above. Accordingly, the external terminal 20 is insulated from the cover part 12 via the gasket 30 and supported by the cover part 12.

Here, the external terminal 20 is coupled to the battery device 40 (the positive electrode 41) via the positive electrode lead 61. The external terminal 20 thus serves as the external coupling terminal for the positive electrode 41. Accordingly, upon use of the secondary battery, the secondary battery is coupled to electronic equipment via the external terminal 20 (the external coupling terminal for the positive electrode 41) and the outer package can 10 (the external coupling terminal for the negative electrode 42). This allows the electronic equipment to operate with use of the secondary battery as a power source.

The external terminal 20 is a flat and substantially plate-shaped member, and is disposed inside the recessed part 12H with the gasket 30 interposed therebetween. The external terminal 20 is thus insulated from the cover part 12 via the gasket 30 as described above. Here, the external terminal 20 is placed inside the recessed part 12H so as not to protrude above the cover part 12. A reason for this is that this reduces the height H of the secondary battery and therefore increases the energy density per unit volume as compared with a case where the external terminal 20 protrudes above the cover part 12.

Note that the external terminal 20 has an outer diameter smaller than an inner diameter of the recessed part 12H. Thus, the external terminal 20 is separated from the cover part 12 surrounding the external terminal 20. Accordingly, the gasket 30 is disposed only in a portion of a space between the external terminal 20 and the cover part 12 inside the recessed part 12H. More specifically, the gasket 30 is disposed only at a location where the external terminal 20 and the cover part 12 would be in contact with each other if it were not for the gasket 30.

The external terminal 20 includes one or more of electrically conductive materials including, without limitation, a metal material and an alloy material.

Examples of the electrically conductive materials include aluminum and an aluminum alloy. Note that the external terminal 20 may include a cladding material. The cladding material includes an aluminum layer and a nickel layer that are disposed in order from a side closer to the gasket 30. In the cladding material, the aluminum layer and the nickel layer are roll-bonded to each other.

The gasket 30 is an insulating member disposed between the outer package can 10 (the cover part 12) and the external terminal 20, as illustrated in FIG. 2. The external terminal 20 is fixed to the cover part 12 via the gasket 30. Here, the gasket 30 is ring-shaped in a plan view, and has a through hole at a location corresponding to the through hole 12K. Note that the gasket 30 is not particularly limited in planar shape, and the planar shape may be changed as desired. The gasket 30 includes one or more of insulating materials including, without limitation, a polymer compound having an insulating property. Examples of the insulating materials include polypropylene and polyethylene.

A range of placement of the gasket 30 is not particularly limited, and may be chosen as desired. Here, the gasket 30 is disposed between a top surface of the cover part 12 and a bottom surface of the external terminal 20 inside the recessed part 12H.

The battery device 40 is a power generation device that causes charging and discharging reactions to proceed. As illustrated in FIGS. 2 to 4, the battery device 40 is contained inside the outer package can 10. The battery device 40 includes the positive electrode 41, the negative electrode 42, and the separator 43. Here, the battery device 40 further includes an electrolytic solution which is a liquid electrolyte. The electrolytic solution is not illustrated.

The battery device 40 to be described here is a so-called wound electrode body. That is, in the battery device 40, the positive electrode 41 and the negative electrode 42 are stacked on each other with the separator 43 interposed therebetween, and the stack of the positive electrode 41, the negative electrode 42, and the separator 43 is wound. The positive electrode 41 and the negative electrode 42 are opposed to each other with the separator 43 interposed therebetween, and are wound. As a result, the battery device 40 has a winding center space 40K (having an inner diameter D1). The winding center space 40K is a first through hole extending from the cover part 12 (the upper bottom part M1) toward the container part 11 (the lower bottom part M2). The winding center space 40K is a space provided at a winding center of the battery device 40 (a center around which the positive electrode 41, the negative electrode 42, and the separator 43 are wound).

Here, the positive electrode 41, the negative electrode 42, and the separator 43 are wound in such a manner that the separator 43 is disposed in each of an outermost wind and an innermost wind. Respective numbers of winds of the positive electrode 41, the negative electrode 42, and the separator 43 are not particularly limited, and may be chosen as desired.

The battery device 40 has a three-dimensional shape similar to that of the outer package can 10. The battery device 40 thus has a flat and cylindrical three-dimensional shape. A reason for this is that this helps to prevent a dead space (a surplus space between the outer package can 10 and the battery device 40) from resulting when the battery device 40 is placed inside the outer package can 10, and to thereby allow for efficient use of the internal space of the outer package can 10, as compared with a case where the battery device 40 has a three-dimensional shape different from that of the outer package can 10. As a result, the device space volume increases, and accordingly, the energy density per unit volume increases.

The positive electrode 41 is a first electrode to be used to cause the charging and discharging reactions to proceed. As illustrated in FIG. 4, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

Here, the positive electrode active material layer 41B is provided on each of the two opposed surfaces of the positive electrode current collector 41A. The positive electrode active material layer 41B includes one or more of positive electrode active materials into which lithium is insertable and from which lithium is extractable. Note that the positive electrode active material layer 41B may be provided only on one of the two opposed surfaces of the positive electrode current collector 41A, on a side where the positive electrode 41 is opposed to the negative electrode 42. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. A reason for this is that a high energy density is obtainable. Note that the lithium compound may further include one or more of other elements (elements other than lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 is a second electrode to be used to cause the charging and discharging reactions to proceed. As illustrated in FIG. 4, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

Here, the negative electrode active material layer 42B is provided on each of the two opposed surfaces of the negative electrode current collector 42A. The negative electrode active material layer 42B includes one or more of negative electrode active materials into which lithium is insertable and from which lithium is extractable. Note that the negative electrode active material layer 42B may be provided only on one of the two opposed surfaces of the negative electrode current collector 42A, on a side where the negative electrode 42 is opposed to the positive electrode 41. The negative electrode active material layer 42B may further include other materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 42B is not particularly limited, and specifically includes one or more of methods including, without limitation, a coating method, a vapor-phase method, a liquid-phase method, a thermal spraying method, and a firing (sintering) method.

The negative electrode active material includes a carbon material, a metal-based material, or both, for example. A reason for this is that a high energy density is obtainable. Examples of the carbon material include graphitizable carbon, non-graphitizable carbon, and graphite (natural graphite and artificial graphite). The metal-based material is a material that includes, as a constituent element or constituent elements, one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. In this case, the negative electrode 42 protrudes upward relative to the positive electrode 41, and protrudes downward relative to the positive electrode 41. This is for the purpose of suppressing precipitation of lithium ions extracted from the positive electrode 41 on a surface of the negative electrode 42. The “height” is a dimension corresponding to the height H of the secondary battery described above, that is, a dimension in a vertical direction in each of FIGS. 1 and 2. The definition of the height described here applies also to the following.

The separator 43 is an insulating porous film interposed between the positive electrode 41 and the negative electrode 42 as illustrated in FIGS. 2 and 4. The separator 43 allows lithium ions to pass therethrough while preventing a short circuit between the positive electrode 41 and the negative electrode 42. The separator 43 includes a polymer compound such as polyethylene.

Here, the separator 43 has a height greater than the height of the negative electrode 42. In this case, the separator 43 protrudes upward relative to the negative electrode 42, and protrudes downward relative to the negative electrode 42. This is for the purpose of suppressing contact of the positive electrode 41 and the outer package can 10 (the container part 11 and the cover part 12) with each other.

The electrolytic solution includes a solvent and an electrolyte salt. The positive electrode 41, the negative electrode 42, and the separator 43 are each impregnated with the electrolytic solution. The solvent includes one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents is a so-called non-aqueous electrolytic solution. The electrolyte salt includes one or more of light metal salts including, without limitation, a lithium salt.

As illustrated in FIGS. 2, 3, and 5, the insulating film 50 is an insulating member disposed between the container part 11 (the lower bottom part M2) and the battery device 40. In FIG. 3, the insulating film 50 is shaded lightly.

The insulating film 50 is a substantially flat film-shaped member (having a thickness T), and has a through hole 50K (having an inner diameter D2). The through hole 50K is a second through hole disposed at a position overlapping with the winding center space 40K provided in the battery device 40. As will be described later, disposing the through hole 50K at the position overlapping with the winding center space 40K is for the purpose of allowing a welding electrode to be inserted into each of the winding center space 40K and the through hole 50K in a process of manufacturing the secondary battery (a process of welding the negative electrode lead 62 to the container part 11).

The through hole 50K may be at a position completely matching a position of the winding center space 40K or somewhat deviated from the position of the winding center space 40K. Note that, in a case where the position of the through hole 50K is somewhat deviated with respect to the position of the winding center space 40K, the insulating film 50 is preferably aligned with respect to the battery device 40 to prevent the insulating film 50 (a portion not provided with the through hole 50K) from shielding the winding center space 40K too much. This is for the purpose of allowing a welding electrode to be inserted into each of the winding center space 40K and the through hole 50K as described above.

In particular, the insulating film 50 is adhered in part to a bottom surface of the battery device 40. That is, a portion of the insulating film 50 is adhered to the bottom surface of the battery device 40, whereas another portion of the insulating film 50 is closely attached but not adhered to the bottom surface of the battery device 40.

The insulating film 50 is adhered in part to the bottom surface of the battery device 40 for the following three reasons. Note that details of the three reasons described here will be described later.

A first reason is that the insulating film 50 is fixed to the battery device 40, which helps to prevent the position of the through hole 50K from deviating easily with respect to the position of the winding center space 40K. This makes it easier for the negative electrode lead 62 to be welded to the container part 11 in the process of manufacturing the secondary battery (the process of welding the negative electrode lead 62 to the container part 11).

A second reason is that, in the process of manufacturing the secondary battery (a process of impregnating a wound body 40Z with the electrolytic solution), a gap develops easily between the battery device 40 and the insulating film 50 on an as-needed basis, and using the gap makes it easier for the wound body 40Z to be impregnated with the electrolytic solution. This improves efficiency of impregnating the wound body 40Z with the electrolytic solution, making it easier for the secondary battery to hold the electrolytic solution.

A third reason is that, because it becomes easier for the negative electrode lead 62 to be welded to the container part 11 as described above, the inner diameters D1 and D2 may each be small. This results in an increase in volume of the battery device 40, that is, an increase in respective numbers of winds of the positive electrode 41 and the negative electrode 42.

Specifically, the insulating film 50 includes an adhered part 51 adhered to the bottom surface of the battery device 40, and an unadhered part 52 not adhered to the bottom surface of the battery device 40.

More specifically, the insulating film 50 includes a base layer 53 having an insulating property and a non-adhesion property, and an adhesive layer 54 provided on one surface of the base layer 53. Here, the adhesive layer 54 is provided only on a portion of the one surface of the base layer 53. Accordingly, the adhered part 51 includes the adhesive layer 54, and the unadhered part 52 includes the base layer 53.

The adhesive layer 54 (the adhered part 51) includes one or more of adhesive materials or sticky materials. The adhesive material is not particularly limited in kind as long as it is, for example, a common polymer compound having an adhesion property. A thickness of the adhesive layer 54 is not particularly limited, and may be chosen as desired.

The base layer 53 (the unadhered part 52) includes one or more of insulating materials having a non-adhesion property. The insulating material is not particularly limited in kind as long as it is, for example, a common polymer compound having a non-adhesion property and an insulating property. A thickness of the base layer 53 is not particularly limited, and may be chosen as desired.

A specific configuration of the insulating film 50 is not particularly limited, and may be designed as desired, as long as the insulating film 50 includes the adhered part 51 and the unadhered part 52, and the insulating film 50 is thus adhered in part to the bottom surface of the battery device 40. The “specific configuration of the insulating film 50” includes, without limitation, the number, shapes, and areas of the adhered parts 51, the number, shapes, and areas of the unadhered parts 52, and a positional relationship between the adhered part 51 and the unadhered part 52 (an arrangement pattern of the adhered part 51 and the unadhered part 52).

Here, the adhered part 51 and the unadhered part 52 are alternately disposed in stripes in a direction along an outer diameter of the insulating film 50 (an extending direction of a straight line passing through a center of the insulating film 50). That is, the adhered part 51 and the unadhered part 52 are each band-shaped in a plan view, and the adhered part 51 and the unadhered part 52 are alternately arranged in a so-called striped pattern. A reason for this is that this makes it easier for the insulating film 50 to be sufficiently fixed to the battery device 40, and makes it easier for the wound body 40Z to be sufficiently impregnated with the electrolytic solution.

In this case, the number of the adhered parts 51 is not particularly limited, and may thus be one, or two or more. Similarly, the number of the unadhered parts 52 is not particularly limited, and may thus be one, or two or more.

Further, a width of the adhered part 51 and a width of the unadhered part 52 may each be chosen as desired. The “width” described here is a dimension in the direction in which the adhered part 51 and the unadhered part 52 are alternately disposed. Note that the width of the adhered part 51 and the width of the unadhered part 52 may be the same as or different from each other.

Here, the insulating film 50 includes two adhered parts 51 and three unadhered parts 52, and the adhered parts 51 and the unadhered parts 52 are thus disposed in the order of the unadhered part 52, the adhered part 51, the unadhered part 52, the adhered part 51, and the unadhered part 52. In FIG. 3, for easy understanding of the configuration of the insulating film 50, the two adhered parts 51 are indicated by dashed lines. In FIG. 5, for easy distinction between the adhered part 51 and the unadhered part 52, the adhered part 51 is shaded darkly, and the unadhered part 52 is shaded lightly.

In particular, a range in which the unadhered part 52 is in contact with the through hole 50K is preferably larger than a range in which the adhered part 51 is in contact with the through hole 50K. That is, in a case where the through hole 50K is provided in the insulating film 50, a range (a length) of the unadhered part 52 along an outer periphery of the through hole 50K is preferably larger than a range (a length) of the adhered part 51 along the outer periphery of the through hole 50K. A reason for this is that, when a portion of the electrolytic solution is supplied into the winding center space 40K in the process of manufacturing the secondary battery, a gap develops easily between the wound body 40Z and the unadhered part 52, which makes it easier for the wound body 40Z to be impregnated with the electrolytic solution via the gap.

FIG. 5 illustrates a case where two adhered parts 51 are each in point contact with the through hole 50K, whereas one unadhered part 52 is in line contact with the through hole 50K. Accordingly, the range in which the unadhered part 52 is in contact with the through hole 50K is sufficiently larger than the range in which the adhered part 51 is in contact with the through hole 50K.

In particular, it is more preferable that the through hole 50K be disposed inside the unadhered part 52. A reason for this is that the gap described above develops further easily, which makes it further easier for the wound body 40Z to be impregnated with the electrolytic solution.

FIG. 5 illustrates a case where the through hole 50K is substantially disposed inside the unadhered part 52, because the two adhered parts 51 are each in point contact with the through hole 50K as described above.

Note that a relationship between the area of the adhered part 51 and the area of the unadhered part 52 is not particularly limited, as long as the insulating film 50 is adhered in part to the battery device 40. In a case where the insulating film 50 includes multiple adhered parts 51, the “area of the adhered part 51” is a sum of respective areas, i.e., a total area, of the adhered parts 51. In a case where the insulating film 50 includes multiple unadhered parts 52, the “area of the unadhered part 52” is a sum of respective areas, i.e., a total area, of the unadhered parts 52.

In particular, a ratio of an area S1 of the adhered part 51 to a sum of the area S1 of the adhered part 51 and an area S2 of the unadhered part 52, i.e., an area ratio S(=[S1/(S1+S2)]×100), is preferably within a range from 5% to 85% both inclusive. A reason for this is that the relationship between the area of the adhered part 51 and the area of the unadhered part 52 is optimized, which makes it easier for the insulating film 50 to be sufficiently fixed to the battery device 40, and makes it easier for the wound body 40Z to be sufficiently impregnated with the electrolytic solution.

As illustrated in FIG. 2, the positive electrode lead 61 is a coupling wiring line for the positive electrode 41, being contained inside the outer package can 10 and coupling the positive electrode 41 (the positive electrode current collector 41A) to the external terminal 20. The positive electrode lead 61 is coupled to the positive electrode 41, and coupled to the external terminal 20 via the through hole 12K provided in the cover part 12.

Here, the secondary battery includes one positive electrode lead 61. However, the secondary battery may include two or more positive electrode leads 61. A reason for this is that an increase in the number of the positive electrode leads 61 results in a decrease in electric resistance of the battery device 40.

Although not particularly limited, a method of coupling the positive electrode lead 61 is specifically a welding method. Although not particularly limited in kind, the welding method specifically includes one or more of methods including, without limitation, a resistance welding method, an ultrasonic welding method, and a laser welding method. The details of the welding methods described here apply also to the following.

Details of a material included in the positive electrode lead 61 are similar to the details of the material included in the positive electrode current collector 41A. Note that the material included in the positive electrode lead 61 and the material included in the positive electrode current collector 41A may be the same as or different from each other.

A position of coupling of the positive electrode lead 61 to the positive electrode 41 is not particularly limited, and may be chosen as desired. That is, the positive electrode lead 61 may be coupled to the positive electrode 41 in the outermost wind, in the innermost wind, or in the middle of the winding between the outermost wind and the innermost wind. FIG. 2 illustrates a case where the positive electrode lead 61 is coupled to the positive electrode 41 in the middle of the winding.

Note that the positive electrode lead 61 is physically separate from the positive electrode current collector 41A and is thus provided separately from the positive electrode current collector 41A. Alternatively, the positive electrode lead 61 may be physically continuous with the positive electrode current collector 41A and may thus be provided integrally with the positive electrode current collector 41A.

As illustrated in FIG. 2, the negative electrode lead 62 is a coupling wiring line (an electrode wiring line) for the negative electrode 42, being contained inside the outer package can 10 and coupling the negative electrode 42 (the negative electrode current collector 42A) to the outer package can 10 (the container part 11). The negative electrode lead 62 is coupled to the negative electrode 42, and coupled to the container part 11 (the lower bottom part M2) via the through hole 50K provided in the insulating film 50.

Here, the secondary battery includes one negative electrode lead 62. However, the secondary battery may include two or more negative electrode leads 62. A reason for this is that an increase in the number of the negative electrode leads 62 results in a decrease in electric resistance of the battery device 40.

Details of methods usable for the coupling of the negative electrode lead 62 are similar to the details of the methods usable for the coupling of the positive electrode lead 61. Details of a material included in the negative electrode lead 62 are similar to the details of the material included in the negative electrode current collector 42A. Note that the material included in the negative electrode lead 62 and the material included in the negative electrode current collector 42A may be the same as or different from each other.

A position of coupling of the negative electrode lead 62 to the negative electrode 42 is not particularly limited, and may be chosen as desired. That is, the negative electrode lead 62 may be coupled to the negative electrode 42 in the outermost wind, in the innermost wind, or in the middle of the winding between the outermost wind and the innermost wind. FIG. 2 illustrates a case where the negative electrode lead 62 is coupled to the negative electrode 42 in the outermost wind.

Note that the negative electrode lead 62 is physically separate from the negative electrode current collector 42A and is thus provided separately from the negative electrode current collector 42A. Alternatively, the negative electrode lead 62 may be physically continuous with the negative electrode current collector 42A and may thus be provided integrally with the negative electrode current collector 42A.

Note that the secondary battery may further include one or more of other unillustrated components.

Specifically, the secondary battery includes a safety valve mechanism. The safety valve mechanism cuts off electrical coupling between the outer package can 10 and the battery device 40 (the negative electrode 42) if an internal pressure of the outer package can 10 reaches a certain level or higher. Examples of a factor that causes the internal pressure of the outer package can 10 to reach the certain level or higher include an internal short circuit and heating of the secondary battery. A placement location of the safety valve mechanism is not particularly limited, as long as the safety valve mechanism is placed in the outer package can 10. In particular, the safety valve mechanism is preferably placed on either the container part 11 (the lower bottom part M2) or the cover part 12, more preferably the container part 11 (the lower bottom part M2) to which no external terminal 20 is attached.

Further, the secondary battery includes an additional insulating film between the cover part 12 and the battery device 40. The additional insulating film has a configuration similar to that of the insulating film 50, except for including no adhered part 51.

Further, the secondary battery includes a sealant that covers a periphery of the positive electrode lead 61. The sealant includes one or more of insulating materials including, without limitation, polyimide.

Note that the outer package can 10 is provided with a cleavage valve. The cleavage valve cleaves to release the internal pressure of the outer package can 10 in a case where the internal pressure reaches a certain level or higher. A placement location of the cleavage valve is not particularly limited, as long as the cleavage valve is placed in the outer package can 10. In particular, as with the placement location of the safety valve mechanism described above, the cleavage valve is preferably placed on either the container part 11 (the lower bottom part M2) or the cover part 12, more preferably the container part 11 (the lower bottom part M2).

Upon charging of the secondary battery, in the battery device 40, lithium is extracted from the positive electrode 41, and the extracted lithium is inserted into the negative electrode 42 via the electrolytic solution. Upon discharging of the secondary battery, in the battery device 40, lithium is extracted from the negative electrode 42, and the extracted lithium is inserted into the positive electrode 41 via the electrolytic solution. Upon the charging and the discharging, lithium is inserted and extracted in an ionic state.

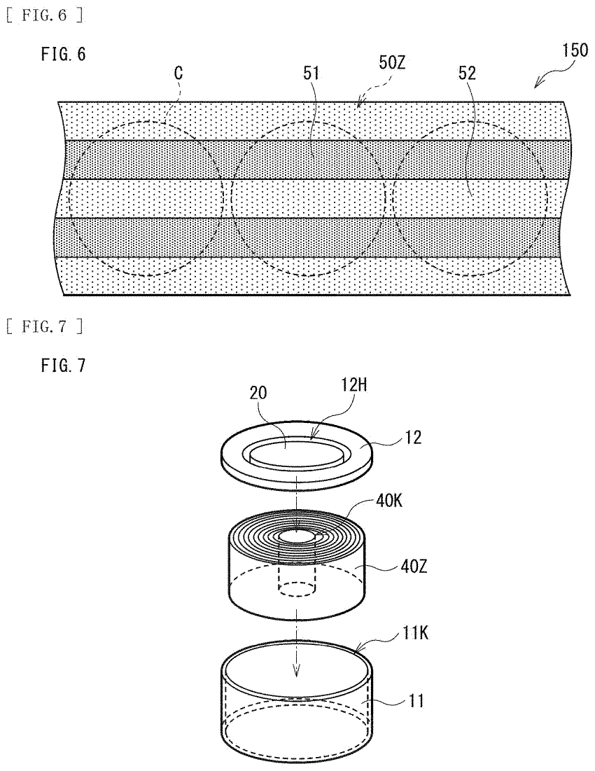

FIG. 6 illustrates a planar configuration corresponding to FIG. 5 to describe a process of forming the insulating film 50. FIG. 7 illustrates a perspective configuration corresponding to FIG. 1 to describe the process of manufacturing the secondary battery.

Note that FIG. 6 illustrates a precursor film 150 to be used to form the insulating film 50. FIG. 7 illustrates a state where the cover part 12 is yet to be welded to the container part 11 and is thus separate from the container part 11. Note that in FIG. 7, for simplifying the illustration, the positive electrode lead 61 and the negative electrode lead 62 are each omitted.

In the following description, where appropriate, FIGS. 1 to 5 described already will be referred to in conjunction with FIGS. 6 and 7. In the following, a description is given of a preparation process before manufacture of the secondary battery, and thereafter a description is given of the process of manufacturing the secondary battery.

Here, as illustrated in FIG. 6, the precursor film 150 having a band shape is used to form the insulating film 50. The precursor film 150 includes the adhered part 51 and the unadhered part 52. The adhered part 51 and the unadhered part 52 each have a band shape extending in a longer direction (a horizontal direction), and the adhered part 51 and the unadhered part 52 are alternately disposed in stripes in a shorter direction (a vertical direction).

In a case of forming the insulating film 50, the precursor film 150 is cut along a cutting line C to thereby obtain a precursor film 50Z. In this case, if the adhered part 51 and the unadhered part 52 are alternately disposed in stripes in the precursor film 150, cutting the precursor film 150 along multiple cutting lines C allows multiple precursor films 50Z to be obtained with use of one precursor film 150.

Thereafter, a portion of the precursor film 50Z is opened by means of a drilling instrument such as a drill to thereby form the insulating film 50 including the adhered part 51 and the unadhered part 52 and having the through hole 50K, as illustrated in FIG. 5. This makes it possible to form the insulating film 50 easily and stably. In this case, in particular, multiple precursor films 50Z are obtained with use of one precursor film 150 as described above, which facilitates mass production of the insulating film 50.

Here, as illustrated in FIG. 7, the container part 11 and the cover part 12 that are physically separate from each other are used to form the outer package can 10. The container part 11 is a member in which the lower bottom part M2 and the sidewall part M3 are integrated with each other, and has the opening 11K, as described above. The external terminal 20 is attached in advance, via the gasket 30, to the recessed part 12H provided in the cover part 12 as described above.

Alternatively, the lower bottom part M2 and the sidewall part M3 may be physically separate from each other, and the container part 11 may thus be formed by welding the sidewall part M3 to the lower bottom part M2.

With use of the container part 11, the cover part 12, and the insulating film 50 described above, the secondary battery is manufactured in accordance with a procedure described below.

First, the positive electrode active material is mixed with other materials including, without limitation, the positive electrode binder and the positive electrode conductor to thereby obtain a positive electrode mixture. Thereafter, the positive electrode mixture is put into a solvent such as an organic solvent to thereby prepare a paste positive electrode mixture slurry. Thereafter, the positive electrode mixture slurry is applied on the two opposed surfaces of the positive electrode current collector 41A to thereby form the positive electrode active material layers 41B. Lastly, the positive electrode active material layers 41B are compression-molded by means of, for example, a roll pressing machine. In this case, the positive electrode active material layers 41B may be heated. The positive electrode active material layers 41B may be compression-molded multiple times. In this manner, the positive electrode 41 is fabricated.

First, the negative electrode active material is mixed with other materials including, without limitation, the negative electrode binder and the negative electrode conductor to thereby obtain a negative electrode mixture. Thereafter, the negative electrode mixture is put into a solvent such as an organic solvent to thereby prepare a paste negative electrode mixture slurry. Thereafter, the negative electrode mixture slurry is applied on the two opposed surfaces of the negative electrode current collector 42A to thereby form the negative electrode active material layers 42B. Lastly, the negative electrode active material layers 42B are compression-molded by means of, for example, a roll pressing machine. Details of the compression molding of the negative electrode active material layers 42B are similar to the details of the compression molding of the positive electrode active material layers 41B. In this manner, the negative electrode 42 is fabricated.

The electrolyte salt is put into the solvent. The electrolyte salt is thereby dispersed or dissolved in the solvent. Thus, the electrolytic solution is prepared.

First, by means of a method such as a welding method, the positive electrode lead 61 is coupled to the positive electrode 41 (the positive electrode current collector 41A), and the negative electrode lead 62 is coupled to the negative electrode 42 (the negative electrode current collector 42A).

Thereafter, the positive electrode 41 with the positive electrode lead 61 coupled thereto and the negative electrode 42 with the negative electrode lead 62 coupled thereto are stacked on each other with the separator 43 interposed therebetween, following which the stack of the positive electrode 41, the negative electrode 42, and the separator 43 is wound to thereby fabricate the wound body 40Z having the winding center space 40K, as illustrated in FIG. 7. The wound body 40Z has a configuration similar to that of the battery device 40 except that the positive electrode 41, the negative electrode 42, and the separator 43 are each unimpregnated with the electrolytic solution.

Thereafter, the insulating film 50 is attached to a bottom surface of the wound body 40Z. In this case, the insulating film 50 is aligned with respect to the wound body 40Z to allow the winding center space 40K and the through hole 50K to overlap with each other, and the insulating film 50 is adhered to the bottom surface of the wound body 40Z via the adhered part 51. In this manner, the insulating film 50 is fixed to the wound body 40Z.

Thereafter, as illustrated in FIG. 7, the wound body 40Z with the positive electrode lead 61 and the negative electrode lead 62 each coupled thereto and the insulating film 50 attached thereto is placed into the container part 11 through the opening 11K. In this case, the negative electrode lead 62 is welded to the container part 11 (the lower bottom part M2) by means of a resistance welding method, with a welding electrode inserted into each of the winding center space 40K and the through hole 50K, to thereby couple the negative electrode lead 62 to the container part 11 via the through hole 50K. A welding point P illustrated in FIG. 3 represents a region in which the negative electrode lead 62 is welded to the container part 11 by means of the resistance welding method (the welding electrode).

Thereafter, the electrolytic solution is injected into the container part 11 through the opening 11K. The wound body 40Z (including the positive electrode 41, the negative electrode 42, and the separator 43) is thereby impregnated with the electrolytic solution. Thus, the battery device 40 which is the wound electrode body is fabricated. In this case, a portion of the electrolytic solution is supplied into the winding center space 40K, and the wound body 40Z is thus impregnated with the electrolytic solution from the inside of the winding center space 40K.

In particular, in a case where the wound body 40Z is impregnated with the electrolytic solution, because a portion (the unadhered part 52) of the insulating film 50 is not adhered to the wound body 40Z, the wound body 40Z is impregnated with the electrolytic solution via a gap that develops between the wound body 40Z and the unadhered part 52. This makes it easier for the wound body 40Z to be impregnated with the electrolytic solution, although the insulating film 50 is fixed (adhered) to the wound body 40Z.

Thereafter, the opening 11K is closed with use of the cover part 12 with the external terminal 20 attached thereto via the gasket 30, following which the cover part 12 is welded to the container part 11 by means of a welding method. In this case, the positive electrode lead 61 is coupled to the external terminal 20 via the through hole 12K, by means of a method such as a welding method.

The container part 11 and the cover part 12 are thus joined to each other. In this manner, the outer package can 10 is formed, and the components including, without limitation, the battery device 40 and the insulating film 50 are contained inside the outer package can 10. The secondary battery is thus assembled.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state.

As a result, the components including, without limitation, the battery device 40 and the insulating film 50 are sealed in the outer package can 10. The secondary battery is thus completed.

According to the secondary battery, the following action and effects are achieved.

In the secondary battery of an embodiment, the battery device 40 having the winding center space 40K is contained inside the outer package can 10 (including the upper bottom part M1 and the lower bottom part M2) having a flat and columnar shape. Further, the insulating film 50 having the through hole 50K at the position overlapping with the winding center space 40K is disposed between the outer package can 10 (the lower bottom part M2) and the battery device 40, and the insulating film 50 is adhered in part to the battery device 40. This makes it possible to improve manufacturing stability and safety while securing the battery capacity for the following reasons.

In the following, the secondary battery of an embodiment and secondary batteries of seven comparative examples are compared with each other, and differences in action and effects between the secondary batteries are described.

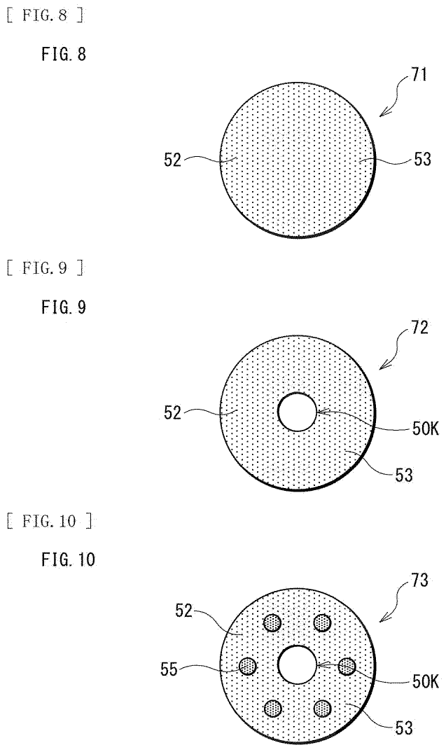

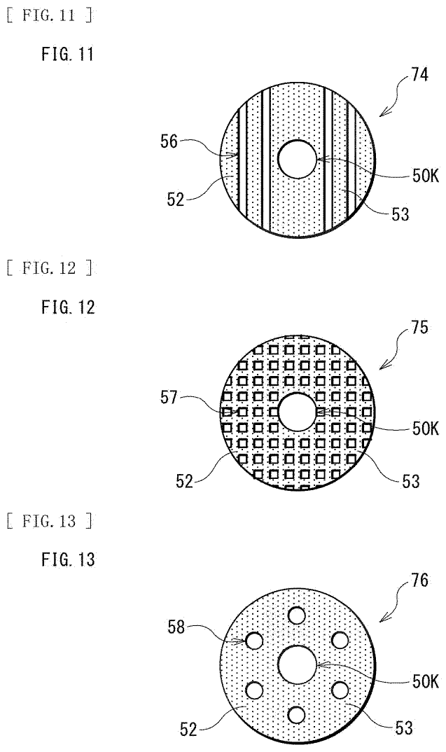

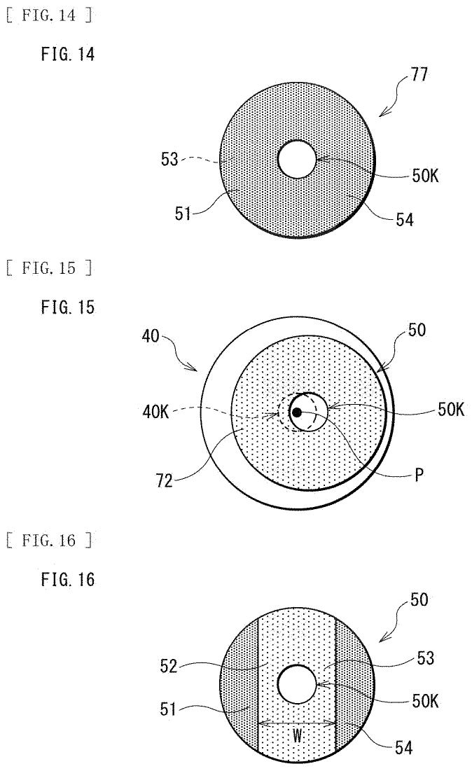

FIG. 8 illustrates a planar configuration of an insulating film 71 to be used for a secondary battery of a first comparative example. FIG. 9 illustrates a planar configuration of an insulating film 72 to be used for a secondary battery of a second comparative example. FIG. 10 illustrates a planar configuration of an insulating film 73 to be used for a secondary battery of a third comparative example. FIG. 11 illustrates a planar configuration of an insulating film 74 to be used for a secondary battery of a fourth comparative example. FIG. 12 illustrates a planar configuration of an insulating film 75 to be used for a secondary battery of a fifth comparative example. FIG. 13 illustrates a planar configuration of an insulating film 76 to be used for a secondary battery of a sixth comparative example. FIG. 14 illustrates a planar configuration of an insulating film 77 to be used for a secondary battery of a seventh comparative example. Note that FIGS. 8 to 14 each correspond to FIG. 5.

FIG. 15 illustrates a planar configuration corresponding to FIG. 3 to describe an issue related to the secondary battery of the second comparative example.

The secondary battery of the first comparative example has a configuration similar to that of the secondary battery of an embodiment, except for including the insulating film 71 illustrated in FIG. 8, instead of the insulating film 50. The insulating film 71 has a configuration similar to that of the insulating film 50, except that the insulating film 71 includes no adhered part 51 (no adhesive layer 54) and has no through hole 50K.

The secondary battery of the second comparative example has a configuration similar to that of the secondary battery of an embodiment, except for including the insulating film 72 illustrated in FIG. 9, instead of the insulating film 50. The insulating film 72 has a configuration similar to that of the insulating film 50, except that the insulating film 72 includes no adhered part 51 (no adhesive layer 54).

The secondary battery of the third comparative example has a configuration similar to that of the secondary battery of an embodiment, except for including the insulating film 73 illustrated in FIG. 10, instead of the insulating film 50. The insulating film 73 has a configuration similar to that of the insulating film 50, except that the insulating film 73 has multiple substantially semicircular projections 55, instead of the adhered part 51 (the adhesive layer 54). Here, the insulating film 73 has six projections 55 disposed around the through hole 50K to be spaced from each other. In FIG. 10, the projections 55 are shaded darkly.

The secondary battery of the fourth comparative example has a configuration similar to that of the secondary battery of an embodiment, except for including the insulating film 74 illustrated in FIG. 11, instead of the insulating film 50. The insulating film 74 has a configuration similar to that of the insulating film 50, except that the insulating film 74 has multiple substantially linear grooves 56, instead of the adhered part 51 (the adhesive layer 54). Here, the insulating film 74 has four grooves 56 arranged to be spaced from each other.

The secondary battery of the fifth comparative example has a configuration similar to that of the secondary battery of an embodiment, except for including the insulating film 75 illustrated in FIG. 12, instead of the insulating film 50. The insulating film 75 has a configuration similar to that of the insulating film 50, except that the insulating film 75 has a meshed shape having multiple openings 57 each having a substantially rectangular opening shape, instead of the adhered part 51 (the adhesive layer 54). Here, the insulating film 75 has the multiple openings 57 disposed in a matrix to be spaced from each other.

The secondary battery of the sixth comparative example has a configuration similar to that of the secondary battery of an embodiment, except for including the insulating film 76 illustrated in FIG. 13, instead of the insulating film 50. The insulating film 76 has a configuration similar to that of the insulating film 50, except that the insulating film 76 has multiple openings 58 each having a substantially circular opening shape, instead of the adhered part 51 (the adhesive layer 54). Here, the insulating film 76 has six openings 58 disposed around the through hole 50K to be spaced from each other.

The secondary battery of the seventh comparative example has a configuration similar to that of the secondary battery of an embodiment, except for including the insulating film 77 illustrated in FIG. 14, instead of the insulating film 50. The insulating film 77 has a configuration similar to that of the insulating film 50, except that the insulating film 77 includes no unadhered part 52 as a result of one surface of the base layer 53 being entirely covered by the adhesive layer 54.

Here, the insulating films 73 and 74 each have a configuration corresponding to a configuration of the insulating plate disclosed in Japanese Unexamined Patent Application Publication No. H10-284046. The insulating films 75 and 76 each have a configuration corresponding to a configuration of the bottom insulating plate disclosed in Japanese Unexamined Patent Application Publication No. 2007-027109.

In the secondary battery of the first comparative example including the insulating film 71 (FIG. 8), the insulating film 71 is not adhered to the bottom surface of the battery device 40, and the insulating film 71 is thus not fixed to the battery device 40. In this case, in the process of manufacturing the secondary battery (the process of impregnating the wound body 40Z with the electrolytic solution), a gap develops easily between the wound body 40Z and the insulating film 71, which makes it easier for the wound body 40Z to be impregnated with the electrolytic solution via the gap. This increases an amount of the electrolytic solution held by the secondary battery, resulting in an increase in battery capacity.

However, because the insulating film 71 has no through hole 50K, in the process of welding the negative electrode lead 62 to the container part 11 by means of a resistance welding method, a welding electrode inserted into the winding center space 40K is indirectly pressed against the negative electrode lead 62 with the insulating film 71 interposed between the welding electrode and the negative electrode lead 62. In this case, it becomes difficult for the negative electrode lead 62 to be welded to the container part 11, which makes it difficult for the negative electrode lead 62 to be fixed to the container part 11. As a result, if the secondary battery undergoes shock such as vibration, the negative electrode lead 62 becomes detached from the container part 11 easily, and a short circuit occurs easily in some cases.

Accordingly, in the secondary battery of the first comparative example, the battery capacity is secured, but the manufacturing stability decreases, and the safety also decreases in some cases.

In the secondary battery of the second comparative example including the insulating film 72 (FIG. 9), the insulating film 72 is not fixed to the battery device 40. This makes it easier for the wound body 40Z to be impregnated with the electrolytic solution, resulting in an increase in battery capacity, as with the secondary battery of the first comparative example.

Moreover, because the insulating film 72 has the through hole 50K, in the process of welding the negative electrode lead 62 to the container part 11 by means of a resistance welding method, a welding electrode inserted into the winding center space 40K is directly pressed against the negative electrode lead 62 via the through hole 50K. In this case, it becomes easier for the negative electrode lead 62 to be welded to the container part 11, which makes it easier for the negative electrode lead 62 to be fixed to the container part 11. As a result, even if the secondary battery undergoes shock such as vibration, the negative electrode lead 62 is prevented from becoming detached from the container part 11 easily, which helps to prevent a short circuit from occurring easily.

However, because the insulating film 72 is not fixed to the battery device 40, if the secondary battery undergoes shock such as vibration, the insulating film 72 deviates with respect to the battery device 40 easily, as illustrated in FIG. 15. In this case, as a result of the position of the through hole 50K deviating with respect to the position of the winding center space 40K, the winding center space 40K is shielded in part, or entirely in a worst case, by the insulating film 72 easily. This makes it difficult for the welding electrode to be directly pressed against the negative electrode lead 62. It thus becomes difficult for the negative electrode lead 62 to be welded to the container part 11, which makes it difficult for the negative electrode lead 62 to be fixed to the container part 11. Eventually, as with the secondary battery of the first comparative example, when the secondary battery undergoes shock such as vibration, the negative electrode lead 62 becomes detached from the container part 11 easily, and a short circuit occurs easily in some cases.

Accordingly, in the secondary battery of the second comparative example, the battery capacity is secured, but the manufacturing stability decreases, and the safety also decreases in some cases, as with the secondary battery of the first comparative example.

In the secondary battery of the third comparative example including the insulating film 73 (FIG. 10), the insulating film 73 is not fixed to the battery device 40. This makes it easier for the wound body 40Z to be impregnated with the electrolytic solution, resulting in an increase in battery capacity, as with the secondary battery of the first comparative example.

Moreover, as with the secondary battery of the second comparative example, because the insulating film 73 has the through hole 50K, the negative electrode lead 62 is welded to the container part 11 easily in the process of welding the negative electrode lead 62 to the container part 11 by means of a resistance welding method. As a result, even if the secondary battery undergoes shock such as vibration, the negative electrode lead 62 is prevented from becoming detached from the container part 11 easily, which helps to prevent a short circuit from occurring easily.

In this case, the insulating film 73 has a surface unevenness structure resulting from the multiple projections 55, which makes it easier for the insulating film 73 to be closely attached to the battery device 40 by utilizing a so-called anchor effect. It thus seems that, as compared with the secondary battery of the second comparative example, a position of the insulating film 73 is prevented from deviating easily even if the secondary battery undergoes shock such as vibration, which makes it easier for the negative electrode lead 62 to be welded to the container part 11.

However, because the insulating film 73 is not completely fixed to the battery device 40, the position of the insulating film 73 still deviates easily depending on a magnitude of the shock that the secondary battery undergoes. In this case, if the position of the insulating film 73 deviates, it eventually becomes difficult for the negative electrode lead 62 to be welded to the container part 11. As a result, as with the secondary battery of the second comparative example, the negative electrode lead 62 becomes detached from the container part 11 easily, and a short circuit occurs easily in some cases, depending on the magnitude of the shock that the secondary battery undergoes.

Accordingly, in the secondary battery of the third comparative example, the battery capacity is secured, but the manufacturing stability decreases, and the safety also decreases in some cases, as with the secondary battery of the second comparative example.

In the secondary battery of the fourth comparative example including the insulating film 74 (FIG. 11), the insulating film 74 is not fixed to the battery device 40 and has a surface unevenness structure resulting from the multiple grooves 56. This makes it easier for the wound body 40Z to be impregnated with the electrolytic solution, resulting in an increase in battery capacity, as with the secondary battery of the first comparative example. Further, it seems that, as with the secondary battery of the second comparative example, it becomes easier for the insulating film 73 to be closely attached to the battery device 40 by utilizing an anchor effect, which makes it easier for the negative electrode lead 62 to be welded to the container part 11.

However, as with the secondary battery of the third comparative example, because the insulating film 73 is not completely fixed to the battery device 40, it becomes difficult for the negative electrode lead 62 to be welded to the container part 11, depending on a magnitude of shock that the secondary battery undergoes. As a result, the negative electrode lead 62 becomes detached from the container part 11 easily, and a short circuit occurs easily in some cases, depending on the magnitude of the shock that the secondary battery undergoes.

Accordingly, in the secondary battery of the fourth comparative example, the battery capacity is secured, but the manufacturing stability decreases, and the safety also decreases in some cases, as with the secondary battery of the third comparative example.

In the secondary battery of the fifth comparative example including the insulating film 75 (FIG. 12), the insulating film 75 is not fixed to the battery device 40 and has a surface unevenness structure resulting from the multiple openings 57. In this case, it seems that, as with the secondary battery of the third comparative example, it becomes easier for the wound body 40Z to be impregnated with the electrolytic solution, resulting in an increase in battery capacity, and it becomes easier for the insulating film 75 to be closely attached to the battery device 40 by utilizing an anchor effect, resulting in easier welding of the negative electrode lead 62 to the container part 11.

However, as with the secondary battery of the third comparative example, the insulating film 75 is not completely fixed to the battery device 40. It thus becomes difficult for the negative electrode lead 62 to be welded to the container part 11, depending on a magnitude of shock that the secondary battery undergoes. As a result, the negative electrode lead 62 becomes detached from the container part 11 easily, and a short circuit occurs easily in some cases.

Accordingly, in the secondary battery of the fifth comparative example, the battery capacity is secured, but the manufacturing stability decreases, and the safety also decreases in some cases, as with the secondary battery of the third comparative example.

In the secondary battery of the sixth comparative example including the insulating film 76 (FIG. 13), the insulating film 76 is not fixed to the battery device 40 and has a surface unevenness structure resulting from the multiple openings 58. In this case, it seems that, as with the secondary battery of the third comparative example, it becomes easier for the wound body 40Z to be impregnated with the electrolytic solution, resulting in an increase in battery capacity, and it becomes easier for the insulating film 76 to be closely attached to the battery device 40 by utilizing an anchor effect, resulting in easier welding of the negative electrode lead 62 to the container part 11.

However, as with the secondary battery of the third comparative example, because the insulating film 76 is not completely fixed to the battery device 40, it becomes difficult for the negative electrode lead 62 to be welded to the container part 11, depending on a magnitude of shock that the secondary battery undergoes. As a result, the negative electrode lead 62 becomes detached from the container part 11 easily, and a short circuit occurs easily in some cases.

Accordingly, in the secondary battery of the sixth comparative example, the battery capacity is secured, but the manufacturing stability decreases, and the safety also decreases in some cases, as with the secondary battery of the third comparative example.

In the secondary battery of the seventh comparative example including the insulating film 77 (FIG. 14), the insulating film 77 includes the adhered part 51, and the insulating film 77 is thus completely fixed to the battery device 40. This makes it easier for the negative electrode lead 62 to be welded to the container part 11, which helps to prevent the negative electrode lead 62 from becoming detached from the container part 11 easily, and to prevent a short circuit from occurring easily.

However, the insulating film 77 is entirely adhered to the battery device 40. In this case, it becomes difficult for a gap to develop between the wound body 40Z and the insulating film 77, which makes it difficult for the wound body 40Z to be impregnated with the electrolytic solution. The efficiency of impregnating the wound body 40Z with the electrolytic solution thus decreases. As a result, it becomes difficult for the secondary battery to hold a sufficient amount of the electrolytic solution, which results in a decrease in battery capacity.

Accordingly, in the secondary battery of the seventh comparative example, the manufacturing stability improves, and the safety also improves in some cases, but the battery capacity decreases.

Based upon the foregoing, in the secondary batteries of the first to seventh comparative examples, it is difficult to achieve both improvement of battery performance (the battery capacity) and improvement of the manufacturing stability and the safety.

In the secondary battery of an embodiment including the insulating film 50 (FIG. 5), the insulating film 50 has the through hole 50K, which makes it easier for the negative electrode lead 62 to be welded to the container part 11, as with the secondary battery of the second comparative example. As a result, even if the secondary battery undergoes shock such as vibration, the negative electrode lead 62 is prevented from becoming detached from the container part 11 easily, and a short circuit is prevented from occurring easily.

Moreover, the insulating film 50 is adhered in part to the battery device 40 instead of having a surface unevenness structure, and the insulating film 50 is thus fixed in part to the battery device 40. In this case, as compared with the secondary batteries of the third to sixth comparative examples, it becomes easier for the negative electrode lead 62 to be welded to the container part 11 regardless of the magnitude of the shock that the secondary battery undergoes, which helps to prevent the negative electrode lead 62 from becoming detached from the container part 11 easily, and causes a short circuit to occur easily.

Further, because the insulating film 50 is adhered in part to the battery device 40, a portion of the insulating film 50 is not adhered to the battery device 40. In this case, a gap develops in part between the wound body 40Z and the insulating film 50 easily, which makes it easier for the wound body 40Z to be impregnated with the electrolytic solution via the gap. The efficiency of impregnating the wound body 40Z with the electrolytic solution thus improves. As a result, the amount of the electrolytic solution held by the secondary battery increases, which results in an increase in battery capacity.

Further, because it becomes easier for the negative electrode lead 62 to be welded to the container part 11 as described above, the inner diameters D1 and D2 may each be small. This results in an increase in volume of the battery device 40, that is, an increase in respective numbers of winds of the positive electrode 41 and the negative electrode 42, resulting in a further increase in battery capacity.

Based upon the foregoing, in the secondary battery of an embodiment, both improvement of the battery performance (the battery capacity) and improvement of the manufacturing stability and the safety are achieved. This makes it possible to improve the manufacturing stability and the safety while securing the battery capacity.

In particular, the secondary battery of an embodiment makes it possible to achieve the improvement of both the battery capacity and the improvement of the manufacturing stability and the safety, even in a flat and columnar secondary battery referred to by a term such as the coin type or the button type, that is, a small-sized secondary battery which is highly constrained in terms of size.

In the secondary battery of an embodiment, the insulating film 50 may include the adhered part 51 and the unadhered part 52. Thus, the adhered part 51 is used to adhere the insulating film 50 to the battery device 40, and the unadhered part 52 is used to impregnate the wound body 40Z with the electrolytic solution. This allows both the improvement of the battery capacity and the improvement of the manufacturing stability and the safety to be achieved easily and stably. Accordingly, it is possible to achieve higher effects.

In this case, the unadhered part 52 may include the base layer 53 having a non-adhesion property and an insulating property, and the adhered part 51 may include the adhesive layer 54 provided on one surface of the base layer 53. This allows both the improvement of the battery capacity and the improvement of the manufacturing stability and the safety to be achieved further easily and stably. Accordingly, it is possible to achieve further higher effects. Moreover, the adhered part 51 (the adhesive layer 54) serves as a so-called cushioning medium (a shock absorber). As a result, even if the secondary battery undergoes shock such as vibration, the negative electrode lead 62 is further prevented from becoming detached from the container part 11 easily. It is thus possible to achieve further higher effects in this regard.

Further, the adhered part 51 and the unadhered part 52 may be alternately disposed in stripes. This makes it easier for the insulating film 50 to be sufficiently adhered to the battery device 40, and makes it easier for the wound body 40Z to be sufficiently impregnated with the electrolytic solution. Accordingly, it is possible to achieve higher effects.

In this case, the area ratio S may be within a range from 5% to 85% both inclusive. This optimizes the relationship between the area of the adhered part 51 and the area of the unadhered part 52. This makes it further easier for the insulating film 50 to be fixed to the battery device 40, and further easier for the wound body 40Z to be impregnated with the electrolytic solution. Accordingly, it is possible to achieve further higher effects.

Further, the range in which the unadhered part 52 is in contact with the through hole 50K may be larger than the range in which the adhered part 51 is in contact with the through hole 50K. This makes it easier for the wound body 40Z to be impregnated with the electrolytic solution via a gap that develops between the wound body 40Z and the unadhered part 52. Accordingly, it is possible to achieve higher effects.

In this case, the through hole 50K may be disposed inside the unadhered part 52. This makes it further easier for the wound body 40Z to be impregnated with the electrolytic solution. Accordingly, it is possible to achieve further higher effects.

Further, the battery device 40 may be a wound electrode body, and the battery device 40 may have the winding center space 40K. In such a case, in the process of welding the negative electrode lead 62 to the container part 11 by means of a resistance welding method, a welding electrode is inserted into the winding center space 40K. This allows the negative electrode lead 62 to be welded to the outer package can 10 easily and stably. Accordingly, it is possible to achieve higher effects.

In this case, the negative electrode lead 62 coupled to the negative electrode 42 may be coupled to the container part 11 (the lower bottom part M2) via the through hole 50K. This allows the outer package can 10 to serve as the external coupling terminal for the negative electrode 42. It thus becomes possible for the secondary battery to be easily coupled to electronic equipment, using the outer package can 10 as the external coupling terminal for the negative electrode 42. Accordingly, it is possible to achieve higher effects.

Further, the external terminal 20 may be insulated and supported by the outer package can 10 (the upper bottom part M1). In such a case, the insulating film 50 serves as an insulator (a so-called bottom insulator) below the battery device 40. This allows the advantage described above to be obtained using the insulating film 50 serving as the bottom insulator. Accordingly, it is possible to achieve higher effects.

Further, the outer package can 10 may include the container part 11 and the cover part 12, and the cover part 12 may be welded to the container part 11. In such a case, the secondary battery includes the outer package can 10 which is a so-called crimpless welded can. This increases the device space volume, which results in an increase in energy density per unit volume. Accordingly, it is possible to achieve higher effects.

Further, the secondary battery may include a lithium-ion secondary battery. This makes it possible to obtain a sufficient battery capacity stably through the use of insertion and extraction of lithium. Accordingly, it is possible to achieve higher effects.

The configuration of the secondary battery described above is appropriately modifiable, as described below. Note that any two or more of the following series of modifications may be combined with each other.

In FIG. 2, in a case where the adhered part 51 and the unadhered part 52 are each band-shaped in a plan view, and the adhered part 51 and the unadhered part 52 are alternately disposed in stripes, the insulating film 50 includes the two adhered parts 51 and the three unadhered parts 52. However, regarding each of the adhered part 51 and the unadhered part 52, parameters including, without limitation, number and shape may be changed as desired as described above, as long as the adhered part 51 and the unadhered part 52 are alternately disposed in stripes.

Specifically, as illustrated in FIG. 16 corresponding to FIG. 5, the insulating film 50 may include two adhered parts 51 and one unadhered part 52, and the adhered part 51, the unadhered part 52, and the adhered part 51 may be arranged in this order. Here, the two adhered parts 51 are each not in contact with the through hole 50K, and the through hole 50K is thus completely disposed inside the unadhered part 52. In this case also, using the insulating film 50 including the adhered part 51 and the unadhered part 52 improves the manufacturing stability and the safety while securing the battery capacity. Accordingly, it is possible to achieve effects similar to those in the case illustrated in FIG. 5.

In particular, in the case illustrated in FIG. 16, because the through hole 50K is disposed inside the unadhered part 52, a wide gap develops easily between the wound body 40Z and the unadhered part 52 around the through hole 50K. This makes it easier for the wound body 40Z to be impregnated with the electrolytic solution. Accordingly, it is possible to achieve higher effects.

In FIG. 2, the adhered part 51 and the unadhered part 52 are each band-shaped in a plan view, and the adhered part 51 and the unadhered part 52 are alternately disposed in stripes. However, regarding each of the adhered part 51 and the unadhered part 52, parameters including, without limitation, shape may be changed as desired as described above.

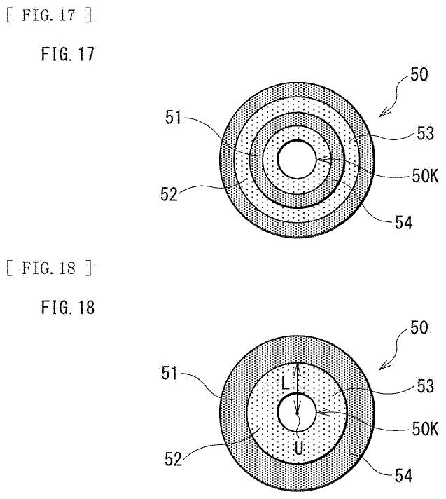

Specifically, as illustrated in each of FIGS. 17 and 18 corresponding to FIG. 5, the adhered part 51 and the unadhered part 52 may each be ring-shaped in a plan view, and the adhered part 51 and the unadhered part 52 may be alternately disposed in concentric circles in a direction from the center toward a periphery of the insulating film 50.

Specifically, in FIG. 17, the insulating film 50 includes two adhered parts 51 and two unadhered parts 52, and the unadhered part 52, the adhered part 51, the unadhered part 52, and the adhered part 51 are disposed in this order in the direction from the center toward the periphery of the insulating film 50. That is, the unadhered part 52 is disposed on an innermost side, the through hole 50K is disposed inside the unadhered part 52, and the adhered part 51 is disposed on an outermost side.

In FIG. 18, the insulating film 50 includes one adhered part 51 and one unadhered part 52, and the unadhered part 52 and the adhered part 51 are disposed in this order in the direction from the center toward the periphery of the insulating film 50. That is, the unadhered part 52 is disposed on an inner side, the through hole 50K is disposed inside the unadhered part 52, and the adhered part 51 is disposed on an outer side.

In these cases also, using the insulating film 50 including the adhered part 51 and the unadhered part 52 improves the manufacturing stability and the safety while securing the battery capacity. Accordingly, it is possible to achieve effects similar to those in the case illustrated in FIG. 5.

In particular, in the respective cases illustrated in FIGS. 17 and 18, as a result of the adhered part 51 and the unadhered part 52 being alternately disposed in concentric circles, the through hole 50K is disposed inside the unadhered part 52 if the unadhered part 52 is disposed in the innermost side. This makes it easier for the wound body 40Z to be impregnated with the electrolytic solution. Accordingly, it is possible to achieve higher effects.

In FIG. 2, the positive electrode 41 is coupled to the external terminal 20 via the positive electrode lead 61, and the negative electrode 42 is coupled to the outer package can 10 (the container part 11) via the negative electrode lead 62. Thus, the external terminal 20 serves as the external coupling terminal for the positive electrode 41, and the outer package can 10 serves as the external coupling terminal for the negative electrode 42.

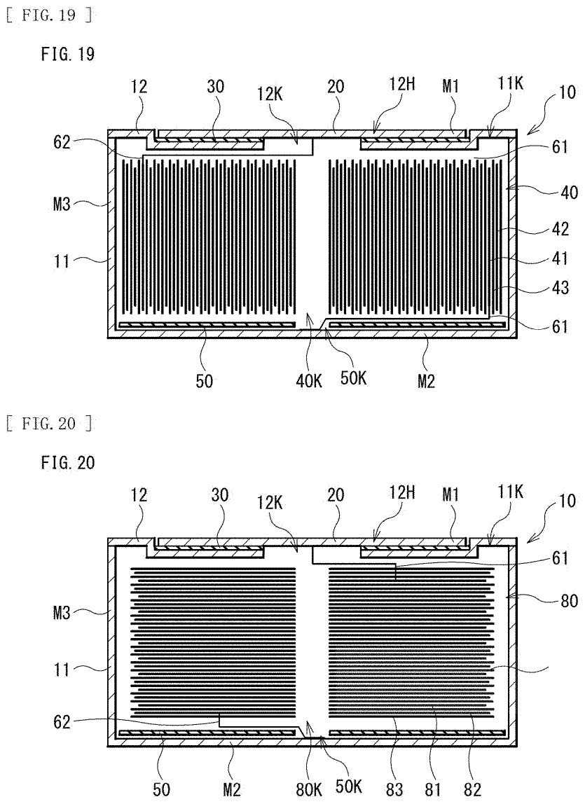

However, as illustrated in FIG. 19 corresponding to FIG. 2, the positive electrode 41 may be coupled to the outer package can 10 (the container part 11) via the positive electrode lead 61, and the negative electrode 42 may be coupled to the external terminal 20 via the negative electrode lead 62. Thus, the outer package can 10 may serve as the external coupling terminal for the positive electrode 41, and the external terminal 20 may serve as the external coupling terminal for the negative electrode 42. The positive electrode lead 61 is an electrode wiring line coupled to the positive electrode 41, and coupled to the container part 11 (the lower bottom part M2) via the through hole 50K. Here, the negative electrode lead 62 is coupled to the negative electrode 42 in the middle of the winding, and the positive electrode lead 61 is coupled to the positive electrode 41 in the outermost wind.

In this case, to serve as the external coupling terminal for the negative electrode 42, the external terminal 20 includes one or more of electrically conductive materials including, without limitation, a metal material and an alloy material. Examples of the electrically conductive materials include iron, copper, nickel, stainless steel, an iron alloy, a copper alloy, and a nickel alloy. To serve as the external coupling terminal for the positive electrode 41, the outer package can 10 includes one or more of electrically conductive materials including, without limitation, a metal material and an alloy material. Examples of the electrically conductive materials include aluminum, an aluminum alloy, and stainless steel.

In this case also, the secondary battery is couplable to electronic equipment via the external terminal 20 (the external coupling terminal for the negative electrode 42) and the outer package can 10 (the external coupling terminal for the positive electrode 41). Accordingly, it is possible to achieve effects similar to those in the case illustrated in FIG. 2.

In FIG. 2, the secondary battery includes the battery device 40 (including the positive electrode 41, the negative electrode 42, and the separator 43) which is the wound electrode body. However, as illustrated in FIG. 20 corresponding to FIG. 2, the secondary battery may include a battery device 80 (including a positive electrode 81, a negative electrode 82, and a separator 83) which is a stacked electrode body.

The battery device 80 has a configuration similar to that of the battery device 40, except for the following.

The battery device 80 includes the positive electrode 81, the negative electrode 82, and the separator 83, and the positive electrode 81 and the negative electrode 82 are alternately stacked with the separator 83 interposed therebetween. Accordingly, the battery device 80 includes one or more positive electrodes 81, one or more negative electrodes 82, and one or more separators 83. In the battery device 80, a through hole 80K is provided to penetrate each of the positive electrode 81, the negative electrode 82, and the separator 83 from the cover part 12 toward the container part 11 (the lower bottom part M2). The through hole 80K is a second through hole related to the battery device 80 which is the stacked electrode body. Configurations of the positive electrode 81, the negative electrode 82, and the separator 83 are respectively similar to those of the positive electrode 41, the negative electrode 42, and the separator 43.

Here, the battery device 80 includes multiple positive electrodes 81, multiple negative electrodes 82, and multiple separators 83. Although the illustration in FIG. 20 is simplified, the secondary battery includes multiple positive electrode leads 61 coupled to respective ones of the multiple positive electrodes 81 (positive electrode current collectors), and multiple negative electrode leads 62 coupled to respective ones of the multiple negative electrodes 82 (negative electrode current collectors). The multiple positive electrode leads 61 are coupled to the external terminal 20 in a state of being joined to each other, and the multiple negative electrode leads 62 are coupled to the outer package can 10 (the container part 11) in a state of being joined to each other.

In this case also, using the insulating film 50 improves the manufacturing stability and the safety while securing the battery capacity. Accordingly, it is possible to achieve effects similar to those in the case illustrated in FIG. 2.

In FIG. 2, the insulating film 50 is disposed between the battery device 40 and the container part 11 (lower bottom part M1), and thus serves as the insulator (the bottom insulator) below the battery device 40.

However, although not specifically illustrated here, the insulating film 50 may be disposed between the battery device 40 and the cover part 12, and may thus serve as an insulator (a so-called top insulator) above the battery device 40. The insulating film 50 serving as the top insulator has a configuration similar to that of the insulating film 50 serving as the bottom insulator, except that the insulating film 50 serving as the top insulator is adhered in part to a top surface instead of the bottom surface of the battery device 40. In this case also, the insulating film 50 having the through hole 50K is adhered in part to the top surface of the battery device 40. Accordingly, it is possible to achieve similar effects.

### EXAMPLES

Examples of the present technology are described below according to an embodiment.

### Example 1 and Comparative Examples 1-1 to 1-10

Secondary batteries were fabricated, and thereafter the secondary batteries were evaluated for their performance. [Fabrication of Secondary Battery of Example 1]

In accordance with a procedure described below, the secondary batteries (lithium-ion secondary batteries) of the button type illustrated in FIGS. 1 to 5 were fabricated.

### (Fabrication of Positive Electrode)

First, 91 parts by mass of the positive electrode active material (LiCoO₂), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone which is an organic solvent), following which the organic solvent was stirred to thereby prepare a paste positive electrode mixture slurry. Thereafter, the positive electrode mixture slurry was applied on the two opposed surfaces of the positive electrode current collector 41A (a band-shaped aluminum foil having a thickness of 12 μm) by means of a coating apparatus, following which the applied positive electrode mixture slurry was dried to thereby form the positive electrode active material layers 41B. Lastly, the positive electrode active material layers 41B were compression-molded by means of a roll pressing machine. In this manner, the positive electrode 41 having a height of 3.8 mm was fabricated.

### (Fabrication of Negative Electrode)

First, 95 parts by mass of the negative electrode active material (graphite) and 5 parts by mass of the negative electrode binder (polyvinylidene difluoride) were mixed with each other to thereby obtain a negative electrode mixture. Thereafter, the negative electrode mixture was put into a solvent (N-methyl-2-pyrrolidone which is an organic solvent), following which the organic solvent was stirred to thereby prepare a paste negative electrode mixture slurry. Thereafter, the positive electrode mixture slurry was applied on the two opposed surfaces of the negative electrode current collector 42A (a band-shaped copper foil having a thickness of 15 μm) by means of a coating apparatus, following which the applied negative electrode mixture slurry was dried to thereby form the negative electrode active material layers 42B. Lastly, the negative electrode active material layers 42B were compression-molded by means of a roll pressing machine. In this manner, the negative electrode 42 having a height of 4.3 mm was fabricated.

### (Preparation of Electrolytic Solution)

The electrolyte salt (LiPF₆) was added to the solvent (ethylene carbonate and diethyl carbonate), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. Thus, the electrolytic solution was prepared.

### (Assembly of Secondary Battery)

First, by means of a resistance welding method, the positive electrode lead 61 (including a 0.1-mm-thick aluminum wire and having a width of 2 mm) was welded to the positive electrode 41 (the positive electrode current collector 41A), and the negative electrode lead 62 (including a 0.1-mm-thick aluminum wire and having a width of 2 mm) was welded to the negative electrode 42 (the negative electrode current collector 42A).

Thereafter, the positive electrode 41 with the positive electrode lead 61 coupled thereto and the negative electrode 42 with the negative electrode lead 62 coupled thereto were stacked on each other with the separator 43 (a polyethylene film having a thickness of 10 μm) having a height of 4.55 mm interposed therebetween. Thereafter, the stack of the positive electrode 41, the negative electrode 42, and the separator 43 was wound about an unillustrated jig (a winding core shaft), to thereby fabricate the wound body 40Z having the winding center space 40K (having the inner diameter D1). In this case, an outer diameter of the winding core shaft was changed to thereby vary the inner diameter D1 (mm) as indicated in Table 1.

Thereafter, the insulating film 50 (having an outer diameter of 11.6 mm) having the through hole 50K was attached to the bottom surface of the wound body 40Z. In this case, the insulating film 50 was aligned with respect to the wound body 40Z to allow the winding center space 40K and the through hole 50K to overlap with each other.

In the column of “configuration (corresponding figure)” in Table 1, a configuration of an insulating film used for fabricating the secondary battery is written, together with a figure corresponding to the configuration of the insulating film. Further, in the column of “through hole” in Table 1, presence or absence of the through hole 50K is written.

Here, the insulating film 50 (FIG. 5) including the adhered part 51 (the adhesive layer 54) and the unadhered part 52 (the base layer 53) was used, and the inner diameter D2 (mm) and the thickness T (mm) were each as indicated in Table 1.

In the insulating film 50, the adhesive layer 54 (an epoxy-based adhesive having a thickness of 0.05 mm) was provided on one surface of the base layer 53 (a polyethylene terephthalate (PET) film having a thickness of 0.05 mm). The thickness T is thus a sum of the thickness of the base layer 53 and the thickness of the adhesive layer 54. As illustrated in FIG. 5, the adhered part 51 and the unadhered part 52 were alternately disposed in stripes to set the area ratio S to 40%. As a result, the insulating film 50 was attached to the wound body 40Z via the adhesive layer 54. In this case, the width of the adhered part 51 was set to 1.9 mm, and the width of the unadhered part 52 was set to 1.9 mm.

Thereafter, the wound body 40Z was placed into the container part 11 (including SUS316 and having an outer diameter of 12 mm and a wall thickness of 0.15 mm) through the opening 11K. In this case, a welding electrode was inserted into the winding center space 40K to thereby weld the negative electrode lead 62 to the container part 11 (the lower bottom part M2) by means of a resistance welding method.

Thereafter, the electrolytic solution was injected into the container part 11 through the opening 11K, following which the cover part 12 (including SUS316 and having an outer diameter of 11.7 mm, a wall thickness of 0.15 mm, a depth of the recessed part 12H of 0.3 mm, an inner diameter of the recessed part 12H of 9 mm, and an inner diameter of the through hole 12K of 3 mm) was welded to the container part 11 by means of a laser welding method. The cover part 12 had the external terminal 20 (including a 0.3-mm-thick aluminum plate and having an outer diameter of 7.2 mm) attached thereto via the gasket 30 (including polypropylene and having a thickness of 0.07 mm). In this case, the positive electrode lead 61 was welded to the external terminal 20 by means of a resistance welding method.

The wound body 40Z (including the positive electrode 41, the negative electrode 42, and the separator 43) was thus impregnated with the electrolytic solution. In this manner, the battery device 40 was fabricated, and the cover part 12 was joined to the container part 11 to thereby form the outer package can 10 (having the outer diameter D of 12 mm and the height H of 5.5 mm). As a result, the components including, without limitation, the battery device 40 and the insulating film 50 were sealed in the outer package can 10. The secondary battery was thus assembled.

### (Stabilization of Secondary Battery)

The secondary battery after being assembled was charged and discharged for one cycle in an ambient temperature environment (at a temperature of 23° C.). Upon the charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 3.0 V. Note that 0.1 C is a value of a current that causes the battery capacity (a theoretical capacity) to be completely discharged in 10 hours, and 0.05 C is a value of a current that causes the battery capacity to be completely discharged in 20 hours.

As a result, a film was formed on the surface of, for example, the negative electrode 42 to thereby electrochemically stabilize the state of the secondary battery. Thus, the secondary battery was completed.

### Fabrication of Secondary Batteries of Comparative Examples 1-1 to 1-10

As indicated in Table 1, secondary batteries were fabricated in accordance with a similar procedure except that the insulating films 71 to 76 were each used instead of the insulating film 50. In this case, the inner diameters D1 and D2 and the thickness T were each varied on an as-needed basis.

In Comparative example 1-1, the insulating film 71 (FIG. 8) including no adhered part 51 (no adhesive layer 54) and having no through hole 50K was used. In a case of welding the negative electrode lead 62 to the container part 11, a laser welding method was used instead of a resistance welding method, because the insulating film 71 had no through hole 50K.

In Comparative examples 1-2 to 1-4, the insulating film 72 (FIG. 8) including no adhered part 51 (no adhesive layer 54) was used.

In Comparative examples 1-5 and 1-6, used was the insulating film 73 (FIG. 10) having the multiple substantially semicircular projections 55 (six projections each having a maximum diameter of 1 mm and a maximum height of 0.05 mm) instead of the adhered part 51 (the adhesive layer 54).

In Comparative examples 1-7 and 1-8, used was the insulating film 74 (FIG. 11) having the multiple linear grooves 56 (four grooves each having a width of 0.6 mm and a depth of 0.1 mm and spaced from each other by 0.5 mm) instead of the adhered part 51 (the adhesive layer 54).

In Comparative example 1-9, used was the insulating film 75 (FIG. 12) having the multiple openings 57 having rectangular shapes (rectangular openings each having an opening shape of 0.6 mm×0.6 mm and spaced from each other by 0.5 mm) instead of the adhered part 51 (the adhesive layer 54).

In Comparative example 1-10, used was the insulating film 76 (FIG. 13) having the multiple openings 58 having circular shapes (six circular openings each having a diameter of 1 mm) instead of the adhered part 51 (the adhesive layer 54).

The insulating films 71 to 76 each had a configuration similar to that of the insulating film 50, except for the configuration described above. Note that, for the purpose of understanding, in Comparative examples 1-2 to 1-10, a resistance welding method was used to weld the negative electrode lead 62 to the container part 11, because the insulating films 72 to 76 each had the through hole 50K.

The secondary batteries were evaluated for their performance (a battery capacity characteristic, the manufacturing stability, and the safety). The evaluation revealed the results presented in Table 1.

### (Battery Capacity Characteristic)

Instead of measuring a battery capacity, attention was focused on the inner diameter D1 of the battery device 40 and the thickness T of the insulating film 50 each having an influence on the battery capacity (the volume of the battery device 40). It was thus examined to which extent the inner diameter D1 and the thickness T were each able to be reduced while securing each of the manufacturing stability and the safety. Being able to reduce each of the inner diameter D1 and the thickness T means that the volume of the battery device 40 increases, resulting in an increase in battery capacity. In contrast, having to increase each of the inner diameter D1 and the thickness T means that the volume of the battery device 40 decreases, resulting in a decrease in battery capacity.

### (Manufacturing Stability)

A welding test was performed to thereby evaluate a situation of welding of the negative electrode lead 62 to the container part 11. Specifically, after the negative electrode lead 62 was welded to the container part 11, it was visually checked whether the negative electrode lead 62 was sufficiently welded to the container part 11, to thereby examine the number of secondary batteries in which the negative electrode lead 62 was not sufficiently welded (the number of welding failures). In this case, the welding test was repeated 100 times to thereby test 100 secondary batteries in the welding test.

### (Safety)

A crushing test was performed to thereby evaluate a situation of ignition of the secondary battery. Specifically, the secondary battery was subjected to a crushing test in accordance with the UN Manual of Tests and Criteria, and it was thereafter visually checked whether the secondary battery ignited, to thereby examine the number of secondary batteries that ignited (the number of ignitions). In this case, the crushing test was repeated 15 times to thereby test 15 secondary batteries in the crushing test.

Further, a vibration test was performed to thereby evaluate a situation of a short circuit of the secondary battery. Specifically, the secondary battery was subjected to a vibration test in accordance with the UN Manual of Tests and Criteria, and thereafter an open circuit voltage (OCV) of the secondary battery was measured, to thereby examine the number of secondary batteries in which a battery voltage dropped by 0.05 V or greater (the number of OCV failures). In this case, the vibration test was repeated 15 times to thereby test 15 secondary batteries in the vibration test.

TABLE 1

| | Insulating film | | | | | Welding test | | |
|---|---|---|---|---|---|---|---|---|
| | | | Inner | | Battery device | Number of | Crushing test | Vibration test |
| | Configuration | Through | diameter D2 | Thickness | Inner diameter | welding | Number of | Number of |
| | (corresponding figure) | hole | (mm) | T (mm) | D1 (mm) | failures | ignitions | OCV failures |
| Example 1 | Adhered part (FIG. 5) | Present | 3 | 0.1 | 3 | 0 | 0 | 0 |
| Comparative | — (FIG. 8) | Absent | — | 0.1 | 3 | 35 | 0 | 0 |
| example 1-1 | | | | | | | | |
| Comparative | — (FIG. 9) | Present | 3 | 0.1 | 3 | 25 | 0 | 0 |
| example 1-2 | | | | | | | | |
| Comparative | — (FIG. 9) | Present | 4 | 0.1 | 4 | 5 | 0 | 0 |
| example 1-3 | | | | | | | | |
| Comparative | — (FIG. 9) | Present | 5 | 0.1 | 5 | 0 | 0 | 0 |
| example 1-4 | | | | | | | | |
| Comparative | Projections (FIG. 10) | Present | 3 | 0.1 | 3 | 0 | 0 | 4 |
| example 1-5 | | | | | | | | |
| Comparative | Projections (FIG. 10) | Present | 3 | 0.2 | 3 | 0 | 0 | 6 |
| example 1-6 | | | | | | | | |
| Comparative | Grooves (FIG. 11) | Present | 3 | 0.1 | 3 | Untestable | Untestable | Untestable |
| example 1-7 | | | | | | | | |
| Comparative | Grooves (FIG. 11) | Present | 3 | 0.2 | 3 | 0 | 0 | 0 |
| example 1-8 | | | | | | | | |
| Comparative | Rectangular openings | Present | 3 | 0.1 | 3 | 0 | 6 | 0 |
| example 1-9 | (FIG. 12) | | | | | | | |
| Comparative | Circular openings | Present | 3 | 0.1 | 3 | 0 | 4 | 0 |
| example 1-10 | (FIG. 13) | | | | | | | |

As indicated in Table 1, the battery capacity characteristic, the manufacturing stability, and the safety each varied depending on the configuration of the insulating film.

### Comparative Example 1-1

Because the insulating film 71 had no through hole 50K, a resistance welding method was not available as the welding method. Further, because the insulating film 71 was interposed between the negative electrode lead 62 and the container part 11, it became difficult for the negative electrode lead 62 to be welded to the container part 11, regardless of the inner diameter D1.

Accordingly, the volume of the battery device 40 was secured, and neither ignition nor an OCV failure occurred, but a welding failure occurred.

### Comparative Examples 1-2 to 1-4

In Comparative examples 1-2 and 1-3, because the insulating film 72 had the through hole 50K, a resistance welding method was available as the welding method. However, the insulating film 72 was not fixed to the battery device 40, which caused the position of the through hole 50K to deviate easily with respect to the position of the winding center space 40K. It thus became difficult for the negative electrode lead 62 to be welded to the container part 11, regardless of each of the inner diameters D1 and D2.

Accordingly, the volume of the battery device 40 was secured, and neither ignition nor an OCV failure occurred, but a welding failure occurred. In this case, if the inner diameters D1 and D2 were each increased, the position of the through hole 50K was prevented from deviating easily with respect to the position of the winding center space 40K, which prevented a welding failure from occurring easily, but a welding failure still occurred.

In Comparative example 1-4, the inner diameters D1 and D2 were each increased. This prevented a welding failure from occurring easily, but the volume of the battery device 40 decreased.

Accordingly, none of a welding failure, ignition, and an OCV failure occurred, but the volume of the battery device 40 decreased.

### Comparative Examples 1-5 and 1-6

Because the insulating film 73 had the through hole 50K, a resistance welding method was available as the welding method. Further, using the multiple projections 55 made it easier for the insulating film 73 to be fixed to the battery device 40, which prevented the position of the through hole 50K from deviating easily with respect to the position of the winding center space 40K. It thus became easier for the negative electrode lead 62 to be welded to the container part 11, regardless of each of the inner diameters D1 and D2.

However, the multiple projections 55 dug into the battery device 40, which caused the separator 43 to be damaged easily, regardless of each of the inner diameters D1 and D2. This caused a short circuit to occur easily.

Accordingly, the volume of the battery device 40 was secured, and neither a welding failure nor ignition occurred, but an OCV failure occurred.

### Comparative Examples 1-7 and 1-8

In Comparative example 1-7, because the insulating film 74 had the through hole 50K, a resistance welding method was available as the welding method. However, setting the depth of the groove 56 to 0.1 mm resulted in failure to form the insulating film 74 having the thickness T of 0.1 mm. The secondary battery was thus unable to be manufactured with use of the insulating film 74. As a result, it was not possible to perform any of the welding test, the crushing test, and the vibration test using the insulating film 74.

In Comparative example 1-8, the thickness T was increased, which allowed the insulating film 74 to be formed. Further, it became easier for the negative electrode lead 62 to be welded to the container part 11, and ignition was prevented from occurring easily. Moreover, a short circuit was prevented from occurring easily. However, the increase in the thickness T resulted in a decrease in volume of the battery device 40.

Accordingly, none of a welding failure, ignition, and an OCV failure occurred, but the volume of the battery device 40 decreased.

### Comparative Example 1-9

Because the insulating film 75 had the through hole 50K, a resistance welding method was available as the welding method. Because the insulating film 75 had the through hole 50K, it also became easier for the negative electrode lead 62 to be welded to the container part 11, regardless of each of the inner diameters D1 and D2. Further, the insulating film 75 did not cause the battery device 40 (the separator 43) to be damaged easily, which prevented a short circuit from occurring easily, regardless of each of the inner diameters D1 and D2.

However, the insulating film 75 had the multiple openings 57. In this case, when the insulating film 75 was closely attached to the battery device 40, an end of the positive electrode 41 came into contact with the outer package can 10 via the opening 57, which caused ignition to occur easily, regardless of each of the inner diameters D1 and D2.

Accordingly, the volume of the battery device 40 was secured, and neither a welding failure nor an OCV failure occurred, but ignition occurred.

### Comparative Example 1-10

Because the insulating film 76 had the through hole 50K, a resistance welding method was available as the welding method. Because the insulating film 76 had the through hole 50K, it also became easier for the negative electrode lead 62 to be welded to the container part 11, regardless of each of the inner diameters D1 and D2. Further, the insulating film 76 did not cause the battery device 40 (the separator 43) to be damaged easily, which prevented a short circuit from occurring easily, regardless of each of the inner diameters D1 and D2.

However, because the insulating film 76 had the multiple openings 58, ignition occurred easily for a reason similar to that for Comparative example 1-9.

Accordingly, as with Comparative example 1-9, the volume of the battery device 40 was secured, and neither a welding failure nor an OCV failure occurred, but ignition occurred.

### Example 1

Because the insulating film 50 had the through hole 50K, a resistance welding method was available as the welding method. Because the insulating film 50 had the through hole 50K, it also became easier for the negative electrode lead 62 to be welded to the container part 11, regardless of each of the inner diameters D1 and D2. Further, the insulating film 50 did not cause the battery device 40 (the separator 43) to be damaged easily, which prevented a short circuit from occurring easily, regardless of each of the inner diameters D1 and D2. In addition, the insulating film 50 had no multiple openings, which prevented ignition from occurring easily.

Accordingly, the volume of the battery device 40 was secured, and none of a welding failure, ignition, and an OCV failure occurred.

### Examples 2-1 to 2-11 and Comparative Example 2

As indicated in Table 2, secondary batteries were fabricated in accordance with a similar procedure except that the insulating film 50 illustrated in FIG. 16 was used instead of the insulating film 50 illustrated in FIG. 5 and the area ratio S (%) was changed, and thereafter the secondary batteries were evaluated for their performance. In a case of varying the area ratio S, a width W (mm) of the unadhered part 52 was varied.

In the column of “arrangement pattern (corresponding figure)” in Table 2, a pattern in which the adhered part 51 and the unadhered part 52 were disposed (the arrangement pattern) is written, together with a figure corresponding to the arrangement pattern.

Note that, in a case where the area ratio S was 100%, the insulating film 77 illustrated in FIG. 14 was used instead of the insulating film 50. In this case, one surface of the base layer 53 was entirely covered by the adhesive layer 54, and the arrangement pattern was thus a so-called solid pattern of the adhered part 51.

Here, as the performance of the secondary batteries, a cyclability characteristic was newly evaluated together with the manufacturing stability described above. In a case of examining the cyclability characteristic, first, the secondary battery was charged and discharged in an ambient temperature environment (at a temperature of 23° C.) to thereby measure a discharge capacity (a first-cycle discharge capacity). Thereafter, the secondary battery was repeatedly charged and discharged in the same environment until the total number of cycles reached 500 to thereby measure the discharge capacity (a 500th-cycle discharge capacity). Lastly, the following was calculated: capacity retention rate (%)=(500th-cycle discharge capacity/first-cycle discharge capacity)×100.

Upon charging, the secondary battery was charged with a constant current of 1 C until a voltage reached 4.4 V, and was thereafter charged with a constant voltage of 4.4 V until a current reached 0.025 C. Upon discharging, the secondary battery was discharged with a constant current of 0.5 C until the voltage reached 3.0 V. In this case, after the secondary battery was charged with a constant current and charged with a constant voltage, the secondary battery was discharged after elapse of an interruption time of 5 minutes. Note that 1 C, 0.025 C, and 0.5 C are values of currents that cause the battery capacity (the theoretical capacity) to be completely discharged in 1 hour, 40 hours, and 2 hours, respectively.

TABLE 2

| | | | | | Cyclability |
|---|---|---|---|---|---|
| | Arrangement | | | Welding test | test |
| | pattern | Width | Area | Number of | Capacity |
| | (corresponding | W | ratio S | welding | retention |
| | figure) | (mm) | (%) | failures | rate (%) |
| Comparative | — | 11.6 | 0 | 25 | 91 |
| example 1-2 | | | | | |
| Example 2-1 | Stripes | 10.3 | 5 | 0 | 93 |
| Example 2-2 | (FIG. 16) | 9.5 | 10 | 0 | 88 |
| Example 2-3 | | 8.1 | 20 | 0 | 86 |
| Example 2-4 | | 7.0 | 30 | 0 | 84 |
| Example 2-5 | | 6.0 | 40 | 0 | 82 |
| Example 2-6 | | 5.0 | 50 | 0 | 80 |
| Example 2-7 | | 4.1 | 60 | 0 | 83 |
| Example 2-8 | | 3.2 | 70 | 0 | 84 |
| Example 2-9 | | 2.1 | 80 | 0 | 83 |
| Example 2-10 | | 1.7 | 85 | 0 | 82 |
| Example 2-11 | | 1.2 | 90 | 0 | 69 |
| Comparative | Adhered part | 0 | 100 | 0 | 58 |
| example 2 | with solid pattern | | | | |
| | (FIG. 14) | | | | |

As indicated in Table 2, in a case where the area ratio S was 100% and the unadhered part 52 was thus absent (Comparative example 2), the insulating film 77 was entirely adhered to the battery device 40. Accordingly, a welding failure did not occur. However, it became difficult for a gap to develop between the battery device 40 and the insulating film 77. This made it difficult for the wound body 40Z to be impregnated with the electrolytic solution, which resulted in a decrease in capacity retention rate.

Note that, in a case where the area ratio S was 0% and the adhered part 51 was thus absent (Comparative example 1-2), it became easier for a gap to develop between the battery device 40 and the insulating film 72. This made it easier for the wound body 40Z to be impregnated with the electrolytic solution, which resulted in an increase in capacity retention rate. However, as described above, the insulating film 72 was not sufficiently fixed to the battery device 40. Accordingly, a welding failure occurred.

In contrast, in a case where the adhered part 51 and the unadhered part 52 were included and the adhered part 51 and the unadhered part 52 were alternately disposed in stripes (Examples 2-1 to 2-11), a different tendency was obtained.

Specifically, in a case where the area ratio S was within a range from 5% to 90% both inclusive and both the adhered part 51 and the unadhered part 52 were thus present, the insulating film 50 was sufficiently adhered to the battery device 40. Accordingly, a welding failure did not occur. In this case, in particular, if the area ratio S was within a range from 5% to 85% both inclusive, an optimized relationship was obtained between the total area of the adhered part 51 having an influence on an amount of the insulating film 50 adhered to the battery device 40, and the total area of the unadhered part 52 having an influence on an ability of the wound body 40Z to be impregnated with the electrolytic solution. This resulted in an increase in capacity retention rate.

Accordingly, in a case where the insulating film 50 in which the adhered part 51 and the unadhered part 52 were alternately disposed in stripes was used, a high capacity retention rate was obtained, while occurrence of a welding failure was suppressed, if the area ratio S was within a range from 5% to 85% both inclusive.

### Examples 3-1 to 3-11

As indicated in Table 3 corresponding to Table 2, secondary batteries were fabricated in accordance with a similar procedure except that the insulating film 50 illustrated in FIG. 18 was used instead of the insulating film 50 illustrated in FIG. 5 and the area ratio S (%) was changed, and thereafter the secondary batteries were evaluated for their performance (the manufacturing stability and the cyclability characteristic). In a case of varying the area ratio S, a radius L (mm) was varied. As illustrated in FIG. 18, in the insulating film 50 having the through hole 50K (having the inner diameter D2 of 3 mm), the “radius L” is a distance from a center U of the insulating film 50 to an outer edge of the unadhered part 52, that is, a radius of a circle including the through hole 50K and the unadhered part 52.

TABLE 3

| | | | | | Cyclability |
|---|---|---|---|---|---|
| | Arrangement | | | Welding test | test |
| | pattern | Radius | Area | Number of | Capacity |
| | (corresponding | L | ratio S | welding | retention |
| | figure) | (mm) | (%) | failures | rate (%) |
| Comparative | — | 5.8 | 0 | 25 | 91 |
| example 1-2 | | | | | |
| Example 3-1 | Concentric | 5.7 | 5 | 0 | 92 |
| Example 3-2 | circles | 5.5 | 10 | 0 | 89 |
| Example 3-3 | (FIG. 17) | 5.2 | 20 | 0 | 82 |
| Example 3-4 | | 4.9 | 30 | 0 | 81 |
| Example 3-5 | | 4.6 | 40 | 0 | 82 |
| Example 3-6 | | 4.2 | 50 | 0 | 84 |
| Example 3-7 | | 3.8 | 60 | 0 | 85 |
| Example 3-8 | | 3.4 | 70 | 0 | 83 |
| Example 3-9 | | 2.9 | 80 | 0 | 82 |
| Example 3-10 | | 2.6 | 85 | 0 | 81 |
| Example 3-11 | | 2.3 | 90 | 0 | 68 |
| Comparative | Adhered part | 1.5 | 100 | 0 | 58 |
| example 2 | with | | | | |
| | solid pattern | | | | |
| | (FIG. 14) | | | | |

As indicated in Table 3, also in a case where the adhered part 51 and the unadhered part 52 were alternately disposed in concentric circles (Examples 3-1 to 3-11), results similar to those in the case where the adhered part 51 and the unadhered part 52 were alternately disposed in stripes (Table 2) were obtained.

Specifically, in a case where the area ratio S was within a range from 5% to 90% both inclusive and both the adhered part 51 and the unadhered part 52 were thus present, a welding failure did not occur, and the capacity retention rate increased if the area ratio S was within a range from 5% to 85% both inclusive.

Accordingly, in a case where the insulating film 50 in which the adhered part 51 and the unadhered part 52 were alternately disposed in concentric circles was used, a high capacity retention rate was obtained, while occurrence of a welding failure was suppressed, if the area ratio S was within a range from 5% to 85% both inclusive.

The results presented in Tables 1 to 3 indicate that, in a case where the battery device 40 having the winding center space 40K was contained inside the outer package can 10 (including the upper bottom part M1 and the lower bottom part M2) having a flat and columnar shape, where the external terminal 20 was insulated and supported by the outer package can 10 (the upper bottom part M1), where the insulating film 50 having the through hole 50K at the position overlapping with the winding center space 40K was disposed between the outer package can (the lower bottom part M2) and the battery device 40, and where the insulating film 50 was adhered in part to the battery device 40, both improvement of the battery capacity characteristic and improvement of the manufacturing stability and the safety were achieved. This made it possible to improve the manufacturing stability and the safety, while securing the battery capacity.

Although the present technology has been described above with reference to one or embodiments including Examples, the configuration of the present technology is not limited thereto, and is therefore modifiable in a variety of ways.

For example, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member having a flat and columnar shape and including a first bottom part and a second bottom part opposed to each other;
a battery device contained inside the outer package member, and having a first through hole extending from the first bottom part toward the second bottom part; and
an insulating member adhered in part to the battery device between the second bottom part and the battery device, and having a second through hole at a position overlapping with the first through hole.

2. The secondary battery according to claim 1, wherein the insulating member includes
an adhered part adhered to the battery device, and
an unadhered part not adhered to the battery device.

3. The secondary battery according to claim 2, wherein
the unadhered part comprises a base layer having an insulating property and a non-adhesion property, and
the adhered part comprises an adhesive layer provided on one surface of the base layer.

4. The secondary battery according to claim 2, wherein the adhered part and the unadhered part are alternately disposed in stripes in a direction along an outer diameter of the insulating member.

5. The secondary battery according to claim 4, wherein a ratio of an area of the adhered part to a sum of the area of the adhered part and an area of the unadhered part is greater than or equal to 5 percent and less than or equal to 85 percent.

6. The secondary battery according to claim 2, wherein the adhered part and the unadhered part are alternately disposed in concentric circles in a direction from a center toward a periphery of the insulating member.

7. The secondary battery according to claim 6, wherein a ratio of an area of the adhered part to a sum of the area of the adhered part and an area of the unadhered part is greater than or equal to 5 percent and less than or equal to 85 percent.

8. The secondary battery according to claim 2, wherein a range in which the unadhered part is in contact with the second through hole is larger than a range in which the adhered part in contact with the second through hole.

9. The secondary battery according to claim 8, wherein the second through hole is disposed inside the unadhered part.

10. The secondary battery according to claim 1, wherein
the battery device includes a first electrode and a second electrode wound with a separator interposed therebetween, and
the first through hole comprises a space provided at a winding center of the battery device.

11. The secondary battery according to claim 1, wherein
the battery device includes a first electrode and a second electrode wound with a separator interposed therebetween, and
the secondary battery further comprises an electrode wiring line coupled to one of the first electrode or the second electrode, and coupled to the second bottom part via the second through hole.

12. The secondary battery according to claim 1, further comprising an electrode terminal supported by the first bottom part and insulated from the first bottom part.

13. The secondary battery according to claim 1, wherein
the outer package member further includes a sidewall part coupled to each of the first bottom part and the second bottom part,
the outer package member includes
a cover member corresponding to the first bottom part, and
a container member containing the battery device inside, the container member corresponding to the second bottom part and the sidewall part, and
the cover member is welded to the container member.

14. The secondary battery according to claim 1, wherein the secondary battery comprises a lithium-ion secondary battery.
